(19) United States
(12) Patent Application Publication
(10) Pub. No.: US 2007/0263518 A1
(43) Pub. Date: Nov. 15, 2007

(54) Optical Head Apparatus and Optical Information Recording/Reproducing Apparatus With the Same

(76) Inventor: Ryuichi Katayama, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 11/792,939

(22) PCT Filed: Dec. 13, 2005
(86) PCT No.: PCT/JP05/22812

§ 371 Date: Jun. 13, 2007

(30) Foreign Application Priority Data
Dec. 14, 2004 (JP) 2004-362078

(51) Int. Cl. G11B 7/135

(52) U.S. Cl. 369/112.03

(57) ABSTRACT

An optical head apparatus includes a light source section having a plurality of light sources configured to output a plurality of light beams whose wavelengths are different from each other. A plurality of output light beams from the light source section are collected onto an optical recording medium by an objective lens. Reflection light beams corresponding to the output light beams reflected by the optical recording medium, and having different wavelengths are detected by a light detecting section. The output light beams outputted from the plurality of light sources and having the different wavelengths and the reflection light beams reflected by the optical recording medium and having the different wavelengths are separated by an optical separating section. An optical diffracting section is provided between the optical separating section and the light detecting section to generate a plurality of diffraction light beams from the reflection light beam reflected by the optical recording medium.

### TECHNICAL FIELD

The present invention relates to an optical head apparatus for carrying out record/reproduction to a plurality of kinds of optical recording media, and an optical information recording/reproducing apparatus that contains the optical head apparatus, and more particularly relates to an optical head apparatus that has an optical diffraction element for detecting a focus error signal, and an optical information recording/reproducing apparatus that contains the optical head apparatus.

### BACKGROUND ART

In recent years, an optical head apparatus for recording and reproducing data onto and from two types of optical recording media such as DVD and CD which are different in standard has been come to practical use. Also, an optical head apparatus is proposed to record and reproduce data onto and from three types of optical recording media of different standards including a standard of HD DVD in addition to the above two kinds of standards. Here, record/reproduction characteristics of an optical recording medium of a specific standard are guaranteed only for a particular wavelength. For example, the record/reproduction characteristics of the optical recording media for the DVD standard and the CD standard are insured only in the wavelengths of a 650 nm band and a 780 nm band, respectively. Also, the record/reproduction characteristics of the optical recording medium for the HD DVD standard is insured only in the wavelength of a 400 nm band. For this reason, the optical head apparatus for performing the record/reproduction to plural kinds of optical recording media, whose standards are different, contains a plurality of light sources for outputting light beams of wavelengths corresponding to the respective standards. For example, the optical head apparatus for performing the record/reproduction to the optical recording media for the DVD standard and the CD standard contains light sources for outputting the lights of the wavelengths of the 650 nm band and the 780 nm band. Also, the optical head apparatus for recording/reproducing the data onto and from the optical recording media for 3 types of different standards, containing the standard of HD DVD in addition to the two types of standards, further contains the light source for outputting the light beam of the wavelength of the 400 nm band corresponding to the HD DVD standard.

In order to miniaturize those optical head apparatuses, the light source of the wavelength of 650 nm for the DVD standard, the light source of the wavelength of 780 nm for the CD standard, a light detector for the DVD standard, a light detector for the CD standard, and the light source of the wavelength of 400 nm for the HD DVD standard, a light detector for the HD DVD standard, which serve as components of the those optical head apparatuses, are required to be integrated or standardized as much as possible. For example, the integration between the light source and the light detector, the integration of the two or three light sources, and the standardization of the two or three light detectors are considered. Among them, since the light detector requires a large number of output pins to output a signal to an external electronic circuit, the standardization of the light detector is effective for reducing the number of the pins. Thus, the miniaturization of the optical head apparatus can be accomplished, including reduction of cables necessary for connection to the external electric circuit.

By the way, as methods of detecting a focus error signal indicating a focus error in an optical lens system of the optical head apparatus, an astigmatism method, a knife edge method, and a spot size method are known. On the optical recording media of a write once type and a rewritable type, grooves for a tracking operation are formed. When the optical recording media are viewed from the side of an input light beam, a concave portion is referred to as a land, and a convex portion is referred to as a groove. When the focus error signal is detected from the reflected light beam from the optical recording media of the write once type and rewritable type, the focus error signal on a position on which a de-focus quantity is 0 is not strictly 0, and the optical recording media has an offset of an opposite sign between the land and the groove in principle. This offset is referred to as an offset caused by groove crossing noise. The knife edge method and the spot size method have the feature in that the offset caused by the groove crossing noise is small, as compared with the astigmatism method.

On the other hand, in the knife edge method and the spot size method, usually, the light beam reflected from the optical recording medium is divided into a plurality of diffraction light beams by using an optical diffraction element, and the divided lights are received by the corresponding light detecting section in a light detector. Here, a ratio between the light quantities of the plurality of divided diffraction light beams is defined on the basis of the wavelength of a light source and a phase difference in the diffraction grating of the optical diffraction element. A pitch between the plurality of diffracted light beams on the light detecting sections is defined on the basis of the wavelength of the light source and a pitch in the diffraction grating of the optical diffraction element. That is, the ratio between the light quantities in the plurality of diffraction lights and the pitch between the plurality of diffraction lights on the light detecting sections cannot be independently designed for each of the plurality of light beams whose wavelengths are different. However, in order to standardize the light detector in the optical head apparatus for performing the record/reproduction to the optical recording media of the plurality of kinds whose standards are different, a ratio of the light quantities of the plurality of diffraction light beams and the pitch between the plurality of diffraction light beams on the light detector are required to be independently designed for each of the plurality of lights whose wavelengths are different. Thus, any idea to deal with the plurality of wavelengths is necessary for the optical diffraction element for detecting the focus error signal.

As the optical head apparatus that has the optical diffraction element for detecting the focus error signal and performs the record/reproduction on the optical recording media based on the DVD standard and the CD standard, the optical head apparatuses are disclosed in Japanese Laid Open Patent Applications (JP-P2001-126304A) (a first related art) and Japanese Laid Open Patent Application (JP-P2001-155375A) (a second related example).

FIG. 1 is a block diagram schematically showing a configuration of an optical head apparatus in the first related art. In a semiconductor laser 1d, a semiconductor laser for outputting a light beam of the wavelength of 650 nm for the DVD standard and a semiconductor laser for outputting a light beam of the wavelength of 780 nm for the CD standard are accommodated in a common package. The light beam of the wavelength of 650 nm outputted from the semiconductor laser 1d transmits an optical diffraction element 17c, and about 50% of the light is reflected by a beam splitter 31, and is reflected by a mirror 32. The reflected light beam transmits a wavelength plate 33, is converted from a linear polarization into a circular polarization, and is converted into a parallel light beam by a collimator lens 2f. The converted light beam is then collected onto a disc 6 serving as the optical recording medium by an objective lens 5a based on the DVD standard. The light beam reflected from the disc 6 transmits the objective lens 5a and the collimator lens 2f in a direction opposite to the input direction to the disc 6, transmits the wavelength plate 33 and is converted from the circular polarization into the linear polarization in which the forward path direction and the polarization direction are orthogonal. The converted light beam is then reflected by the mirror 32. A light quantity of about 50% of the light beam reflected by the mirror 32 transmits the beam splitter 31, transmits an optical diffraction element 7g and a concave lens 34 and is then received by a light detector 9c.

On the other hand, the light beam of the wavelength of 780 nm for the CD that is outputted from the semiconductor laser 1d is divided into the three light beams of a 0-th light and ± primary diffraction light beams by the optical diffraction element 17c. About 50% of the light beam is reflected by the beam splitter 31, is reflected by the mirror 32, transmits the wavelength plate 33 in its original state of the linear polarization and is converted into a parallel light beam by the collimator lens 2f. The transmitting light beam is then collected onto the disc 6 serving as the optical recording medium based on the CD standard by the objective lens 5a. The three light beams reflected from the disc 6 transmits the objective lens 5a and the collimator lens 2f in a direction opposite to the input direction to the disc 6, transmits the wavelength plate 33 in its original state of the linear polarization in which the forward path direction and the polarization direction are same. The transmitting light beam is reflected by the mirror 32. Then, the light beam of about 50% transmits the beam splitter 31, is diffracted by the optical diffraction element 7g, transmits the concave lens 34 and is then received by the light detector 9c.

The optical diffraction element 7g carries out a function for transmitting a polarization component in a particular direction among the input light beams and diffracting the polarization component in a direction orthogonal to the particular direction. The light beam of the wavelength of 650 nm inputted to the optical diffraction element 7g transmits the optical diffraction element 7g, because its polarization component coincides with the particular direction. On the other hand, the light beam of the wavelength of 780 nm inputted to the optical diffraction element 7g is diffracted by the optical diffraction element 7g because its polarization direction coincides with a direction orthogonal to the particular direction. The optical diffraction element 7g is divided into two regions as first and second regions by a straight line passing through the optical axis of the input light beam.

FIG. 2 is a view showing the arrangement of light receiving sections in the light detector 9c and a pattern of light spots on the light detector 9c. A light spot 16k corresponds to the light beam of the wavelength of 650 nm, which transmits the optical diffraction element 17c on the forward path and transmits the optical diffraction element 7g on a return route. This light beam is received by a light receiving section 15u having a 4 divided light receiving regions. On the other hand, light spots 16l and 16m correspond to the light beams of the wavelength of 780 nm, which transmit the optical diffraction element 17c as the 0-th light beam on the forward path and are diffracted into the first and second regions of the optical diffraction element 7g on the return route. They are received by a light receiving section 15v having 4-divided light receiving regions. Light spots 16n and 16o correspond to the light beams of the wavelength of 780 nm, which are diffracted into the + primary diffraction light beams by the optical diffraction element 17c on the forward path, and diffracted into the first and second regions of the optical diffraction element 7g on the return path. They are received by a single light receiving section 15w. Light spots 16p and 16q correspond to the light beams of the wavelength of 780 nm, which are diffracted into the − primary diffraction light beams by the optical diffraction element 17c on the forward path and respectively diffracted into the first and second regions of the optical diffraction element 7g on the return path. They are received by a single light receiving section 15x. The focus error signal for the optical recording medium based on the DVD standard is detected from the output of the light receiving section 15u by an astigmatism method, by using the astigmatism generated when the light beams transmits the beam splitter 31. On the other hand, the focus error signal for the optical recording medium based on the CD standard is detected from the output of the light receiving section 15v by a knife edge method, by using the optical diffraction element 7g.

However, in the optical head apparatus disclosed in the first conventional art, the focus error signals for the optical recording media based on the DVD standard and the CD standard are detected from the outputs of the light receiving section 15u and the light receiving section 15v, respectively. That is, although the light detecting sections for the DVD and the CD are standardized, the light receiving sections are not standardized. Thus, the number of the pins required to output the signals in the light detecting sections is not decreased, which cannot miniaturize the optical head apparatus including the cables necessary for the connection to the external electric circuit.

FIG. 3 shows a schematic configuration of the optical head apparatus disclosed in the second conventional art. In a semiconductor laser 1f, a semiconductor laser for outputting the light beam of the wavelength of 650 nm for the DVD and a semiconductor laser for outputting the light beam of the wavelength of 780 nm for the CD are integrated. The semiconductor laser 1f and a light detector 9d are accommodated in a common package. The light beam of the wavelength of 650 nm outputted from the semiconductor laser 1f transmits an optical diffraction element 7i and an optical diffraction element 7h, transmits a ¼ wavelength plate 4a, and is converted from the linear polarization into the circular polarization. The converted light beam is converted into a parallel light beam by the collimator lens 2f and is then collected onto the disc 6 serving as the optical recording medium based on the DVD standard by the objective lens 5a. The light beam reflected from the disc 6 transmits the objective lens 5a and the collimator lens 2f in a direction opposite to the input direction to the disc 6, transmits the ¼ wavelength plate 4a, and is converted from the circular polarization into the linear polarization in which a forward path direction and a polarization direction are orthogonal. The converted light signal is diffracted by the optical diffraction element 7h, transmits the optical diffraction element 7i, and is then received by the light detector 9d. On the other hand, the light beam of the wavelength of 780 nm for the CD, which is outputted from the semiconductor laser 1f, transmits the optical diffraction element 7i and the optical diffraction element 7h, transmits the ¼ wavelength plate 4a, and is converted from the linear polarization into the circular polarization. The converted light beam is converted into a parallel light beam by the collimator lens 2f and is then collected onto the disc 6 serving as the optical recording medium based on the CD standard by the objective lens 5a. The light beam reflected from the disc 6 transmits the objective lens 5a and the collimator lens 2f in a direction opposite to the input direction to the disc 6, transmits the ¼ wavelength plate 4a, and is converted from the circular polarization into the linear polarization in which the forward path and the polarization direction are orthogonal. The converted light beam transmits the optical diffraction element 7h, is diffracted by the optical diffraction element 7i, and is then received by the light detector 9d.

FIG. 4 is a sectional view of the optical diffraction element 7h and the optical diffraction element 7i. The optical diffraction element 7h contains a diffraction grating 12k, which is formed on a substrate 11f and has a birefringence property; and a filling material 13k filled thereon, and then carries out a function for transmitting a polarization component in a particular direction among the input light beams for the light beam of the wavelength of 650 nm, and diffracting the polarization component in a direction orthogonal to the particular direction. Also, this carries out a function for transmitting the input light beam independently of the polarization state for the light beam of the wavelength of 780 nm. The light beam of the wavelength of 650 nm inputted to the optical diffraction element 7h transmits the optical diffraction element 7h because its polarization direction coincides with the particular direction on a forward path, and is diffracted by the optical diffraction element 7h because its polarization direction coincides with the direction orthogonal to the particular direction on the return path.

On the other hand, the optical diffraction element 7i contains a diffraction grating 12l formed on a substrate 11g to have the birefringence property and a filling material 13l filled thereon and carries out a function for transmitting the input light beam independently of the polarization state for the light beam of the wavelength of 650 nm. Also, this has a function for transmitting the polarization component in the particular direction among the input light beams for the light beam of the wavelength of 780 nm, and diffracting the polarization component in a direction orthogonal to the particular direction. The light beam of the wavelength of 780 nm inputted to the optical diffraction element 7i transmits the optical diffraction element 7i because its polarization direction coincides with the particular direction on a forward path, and is diffracted by the optical diffraction element 7i because its polarization direction coincides with the particular direction on the return path.

The focus error signal for the optical recording medium based on the DVD standard is detected from the output of the light detector 9d, for example, by a knife edge method, by using the optical diffraction element 7h. On the other hand, the focus error signal for the optical recording medium based on the CD standard is detected from the output of the light detector 9d, for example, by a knife edge method, by using the optical diffraction element 7i.

However, in the optical head apparatus disclosed in the second related example, the diffraction efficiency in the optical diffraction element cannot be increased for each of the plurality of light beams whose wavelengths are different. This reason will be described below.

In the optical head apparatus disclosed in the second related example, it is supposed that phase differences between a line portions and a space portions in the optical diffraction element 7h and the optical diffraction element 7i for the polarization components in a direction orthogonal to the particular directions in the input light beams are Φ1 and Φ2, respectively. Here, the phase differences Φ1 and Φ2 are inversely proportional to the wavelengths of the input light beams. In the optical diffraction element 7h, the phase difference Φ1 is set to integer times of 2π for the wavelength of 780 nm, not to diffract the light beam of the wavelength of 780 nm. For example, if Φ1=2π is set for the wavelength of 780 nm, Φ1=2.4π is established for the wavelength of 650 nm. At this time, when the sectional shape of the diffraction grating is assumed to be rectangular, the 0-th efficiency of the light beam of the wavelength of 650 nm is 65.5%, and the ± primary diffraction efficiencies are respective 14.0%. Thus, the ± primary diffraction efficiencies are low. If the Φ1 is further increased for the wavelength of 780 nm, there is any condition under which the ± primary diffraction efficiencies of the light beam of the wavelength of 650 nm can be further increased. However, the production of the diffraction grating becomes difficult, which increases a variation in the efficiency with respect to a variation in the wavelength of the light source. On the other hand, in the optical diffraction element 7i, the Φ2 is set to integer times of 2π for the wavelength of 650 nm, not to diffract the light beam of the wavelength of 650 nm. For example, if Φ2=2π is set for the wavelength of 650 nm, Φ2=1.67π is established for the wavelength of 780 nm. At this time, when the sectional shape of the diffraction grating is assumed to be rectangular, the 0-th efficiency of the light beam of the wavelength of 780 nm is 75.0%, and the ± primary diffraction efficiencies are respective 10.1%. Thus, the ± primary diffraction efficiencies are low. If the Φ2 is further increased for the wavelength of 650 nm, there is the condition under which the ± primary diffraction efficiencies of the light beam of the wavelength of 780 nm can be further increased. However, the production of the diffraction grating becomes difficult, which increases a variation in the efficiency with respect to the variation in the wavelength of the light source.

In conjunction with the foregoing description, Japanese Laid Open Patent Application (JP-P 2000-76688A) (a third related art) discloses “Multi-Wavelength Optical Pickup”. The optical pickup in this related art is commonly used for the optical recording media whose use wavelengths are different. The optical pickup in the related art contains a plurality of light sources whose light emission wavelengths are different from each other and which are selectively used on the basis of the use wavelengths of the optical recording media, one or more objective lenses for collecting light beams from the respective light sources as light spots on the record surface of the corresponding optical recording media, a hologram device to which return beams from the respective optical recording media are commonly inputted and which performs a predetermined hologram function on the respective return beams; a single light detecting section for receiving the diffraction beam diffracted by the hologram device and generating a predetermined signal. The hologram device is combined by a plurality of holograms where the hologram function is optimized, correspondingly to the wavelengths of the respective beams emitted by the plurality of light sources.

Also, Japanese Laid Open Patent Application (JP-P 2000-155973A) (a fourth related example) discloses “Optical Head Apparatus”. The optical head apparatus in this related are contains a light source; an objective lens for collecting an output light from the light source onto an optical recording medium; a first optical separator that is installed between the light source and the objective lens and separates an optical path for the reflection light from the optical recording medium from the optical path of the output light from the light source; a second optical separator which further separates the reflection light from the optical recording medium sent through the first optical separator into a first group light beam and a second group light beam; and a light detector for receiving the first group light beam and the second group light beam. The light quantity of the first group light beam is greater than the light quantity of the second group light beam.

Also, Japanese Laid Open Patent Application (JP-P2004-69977A) (a fifth related example) discloses “Diffraction Optical Element and Optical Head Apparatus”. The optical diffraction element in this related are contains at least one transparent substrate; and an optical diffraction element constituted by a diffraction grating formed on at least one surface of the transparent substrate in which the diffraction grating has the grating whose section is stepped and the grating whose section is rectangular. The optical diffraction element has the wavelength selection property to diffract the light beam having one wavelength of the input two light beams whose wavelengths are different and to transmit the light beam having the other wavelength.

Also, Japanese Laid Open Patent Application (JP-A-Heisei, 5-100114) (a sixth related art) discloses “Lamination Wavelength Plate and Circular Polarization Plate”. In the lamination wavelength plate in this related art, a plurality of extension films to give a phase difference of a ½ wavelength to a single color light are laminated such that their optical axes intersect.

### DISCLOSURE OF INVENTION

An object of the present invention to provide an optical head apparatus in which light receiving sections of a light detector are made common to a plurality of kinds of optical recording media, and an optical information recording/reproducing apparatus that contains the optical head apparatus.

Another object of the present invention is to provide a miniaturized optical head apparatus and an optical information recording/reproducing apparatus that contains the optical head apparatus.

Another object of the present invention is to provide an optical head apparatus that the number of pins required to output a signal can be reduced in a light detector and an optical information recording/reproducing apparatus that contains the optical head apparatus.

Another object of the present invention is to provide an optical head apparatus that can cope with a plurality of kinds of optical recording media because a diffraction efficiency of an optical diffraction element for detecting a focus error signal is increased for each of a plurality of light beams whose wavelengths are different, and an optical information recording/reproducing apparatus that contains the optical head apparatus.

In an exemplary aspect of the present invention, the optical head apparatus contains a light source section having a plurality of light sources configured to output a plurality of light beams whose wavelengths are different from each other; an objective lens configured to collect an output light beam as one of the plurality of light beams from the light source section onto an optical recording medium; and a light separating section configured to send the output light beam from the light source section to the objective lens. Here, the output light beam is reflected as a reflection light beam by the optical recording medium, and the reflection light beam is inputted through the objective lens to the light separating section, and the light separating section sends the reflection light beam to a direction different from the light source section. The optical head apparatus of the present invention further contains an optical diffracting section configured to generate a plurality of diffraction light beams from the reflection light beam sent through the light separating section; and a light detector section having light receiving sections configured to receive the plurality of diffraction light beams.

Here, it is preferable that ratios of light quantities of the plurality of diffraction light beams generated by the optical diffracting section are approximately equal to each other over a plurality of the reflection light beams obtained from the plurality of light beams. Also, positions of a plurality of light spots generated on the light receiving sections of the light detector from the plurality of diffraction lights are preferred to be approximately the same over a plurality of reflection light beams obtained from the plurality of diffraction light beams.

Also, the optical diffracting section may include a plurality of diffraction gratings which are respectively provided for a plurality of the reflection light beams obtained from the plurality of light beams, and which are laminated. In this case, a polarization direction of one of said plurality of reflection light beams corresponding to one of said plurality of diffraction gratings among said plurality of reflection light beams inputted to said plurality of diffraction gratings is preferred to be orthogonal to polarization directions of the remaining reflection light beams.

Also, each of the plurality of diffraction gratings is preferred to diffract the corresponding reflection light beam and transmit the remaining reflection light beams and the diffraction lights obtained from the remaining reflection light beams.

Also, the optical diffracting section may further include a plurality of wavelength plates provided for the plurality of diffraction gratings on input sides of the plurality of diffraction gratings, respectively. Then, each of the plurality of wavelength plates may orthogonalize a polarization direction of one of the plurality of reflection light beams corresponding to the diffraction grating corresponding to the wavelength plate to polarization directions of the remaining reflection light beams. The plurality of diffraction gratings are formed of material having birefringence property.

Also, in another exemplary aspect of the present invention, an optical information recording/reproducing apparatus contains the above-mentioned optical head apparatus; a first circuit configured to drive the light source section such that one of the plurality of light beams is outputted as the output light beam; a second circuit configured to generate a reproduction signal and an error signal based on an output signal form the light detector; and a third circuit configured to control a position of the objective lens based on the error signal.

Also, in another exemplary aspect of the present invention, an optical information recording/reproducing method is attained by selectively driving one of a plurality of light sources of a light source section to output as an output light beam, wherein the plurality of light sources can output a plurality of light beams whose wavelengths are different from each other; by sending the output light beam from the light source section to an objective lens through an optical separating section; by collecting the output light beam onto an optical recording medium by the objective lens; by generating a plurality of diffraction light beams by an optical diffracting section from a reflection light beam reflected from the optical recording medium and sent to a direction different from the light source section through the light separating section; by receiving the plurality of diffraction light beams by light receiving sections of a light detector; by generating a reproduction signal and an error signal based on an output signal from the light detector; and by controlling a position of the objective lens based on the error signal.

Also, ratios of light quantities of the plurality of diffraction light beams are approximately equal over the plurality of reflection light beams obtained from the plurality of light beams. Also, positions of a plurality of light spots generated on the light receiving sections of the light detector from the plurality of diffraction light beams are approximately the same over a plurality of the reflection light beams obtained from the plurality of light beams.

Also, when the optical diffracting section may include a plurality of diffraction gratings which are laminated and provided for a plurality of the reflection light beams obtained from the plurality of light beams, respectively, the generating the plurality of diffraction light beams is achieved by diffracting each of the plurality of reflection light beams by a corresponding one of the plurality of diffraction gratings and transmitting the remaining reflection light beams and diffraction light beams obtained from the remaining reflection light beams.

In this case, the generating the plurality of diffraction light beams may be achieved by orthogonalizing a polarization direction of one of the plurality of reflection light beams corresponding to one of said plurality of diffraction gratings among said plurality of reflection light beams inputted to the plurality of diffraction gratings to polarization directions of the remaining reflection light beams.

### BRIEF DESCRIPTION OF DRAWINGS

FIG. 1 is a diagram showing a configuration of an optical head apparatus in a related art;

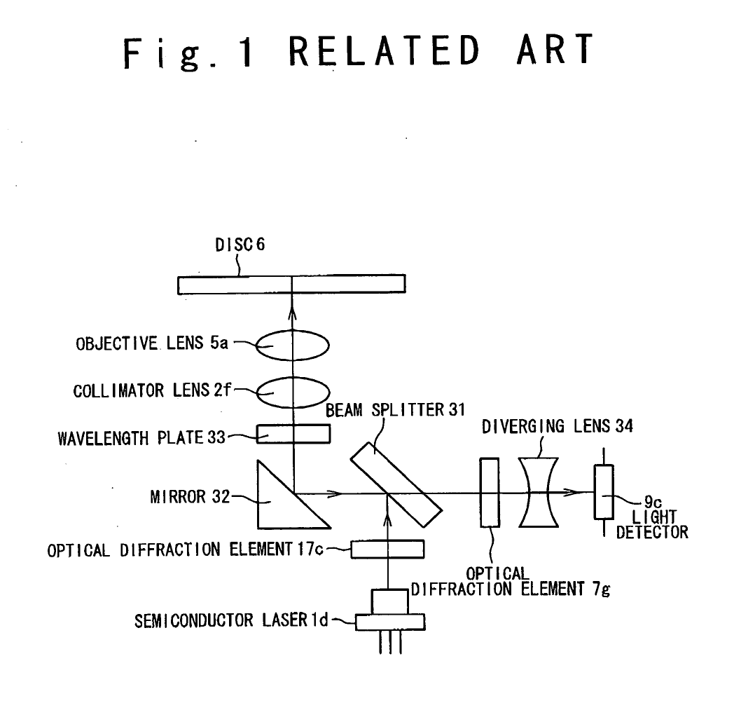

FIG. 2 is a diagram showing an arrangement light receiving sections of a light detecting section and of pattern of light spots on the light detecting section in the optical head apparatus of the related art;

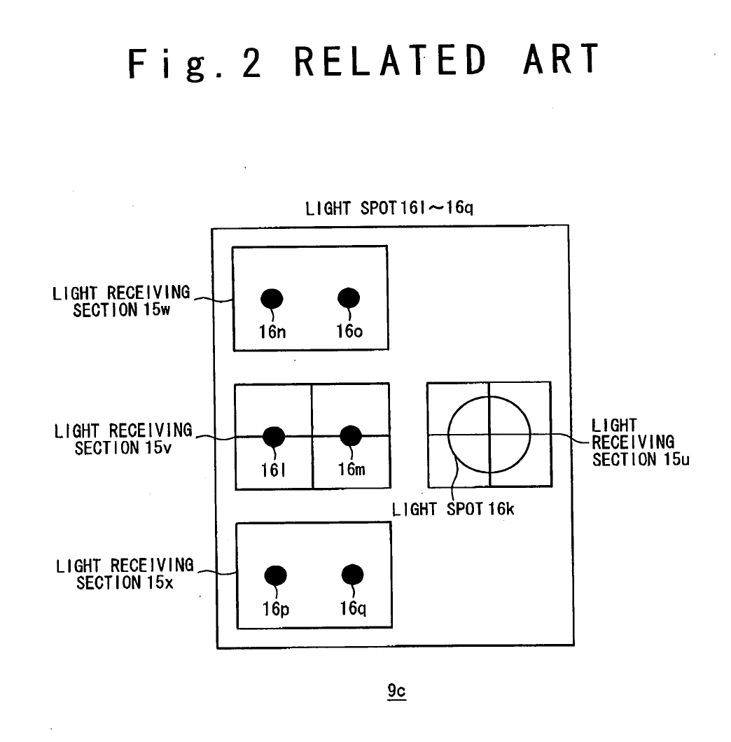

FIG. 3 is a diagram showing the configuration of an optical head apparatus of another related art;

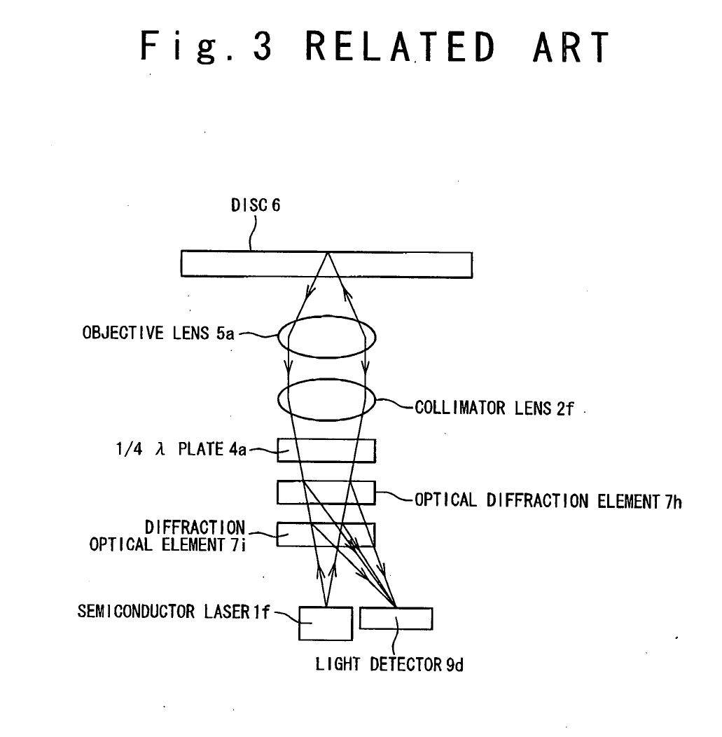

FIG. 4 is a cross sectional view of an optical diffraction element in the optical head apparatus of the other related art;

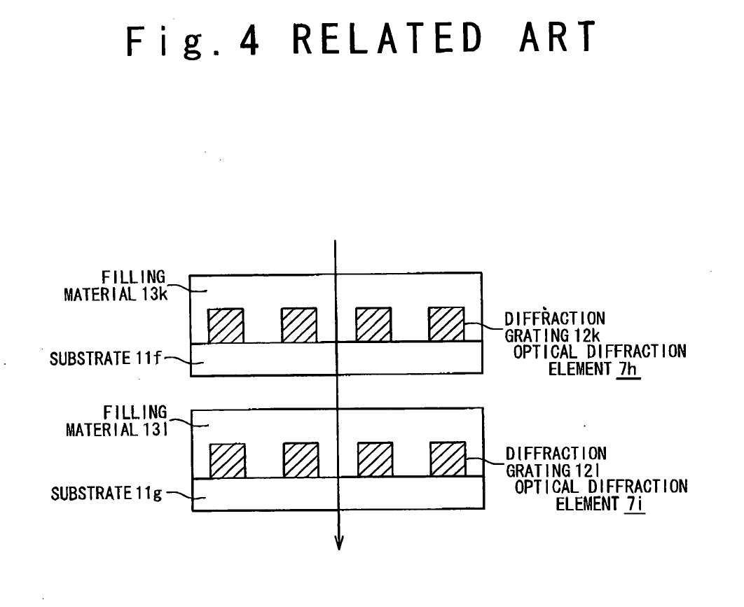

FIG. 5 is a diagram showing a configuration of an optical head apparatus according to a first exemplary embodiment of the present invention;

FIG. 6 is a cross sectional view of an optical diffraction element in the optical head apparatus according to the first exemplary embodiment of the present invention;

FIG. 7 is a plan view of the optical diffraction element in the optical head apparatus according to the first exemplary embodiment of the present invention;

FIG. 8 is a diagram showing an arrangement of light receiving sections of a light detecting section and a pattern of light spots on the light detecting section in the optical head apparatus according to the first exemplary embodiment of the present invention;

FIG. 9 is a diagram showing the configuration of the optical head apparatus according to a second exemplary embodiment of the present invention;

FIG. 10 is a cross sectional view of the optical diffraction element in the optical head apparatus according to the second exemplary embodiment of the present invention;

FIG. 11 is a plan view of the optical diffraction element in the optical head apparatus according to the second exemplary embodiment of the present invention;

FIG. 12 is a diagram showing the configuration of the optical head apparatus according to a third exemplary embodiment of the present invention;

FIG. 13 is a plan view of the optical diffraction element in the optical head apparatus according to the third exemplary embodiment of the present invention;

FIG. 14 is a diagram showing an arrangement of light receiving sections of a light detecting section and a pattern light spots on the light detecting section in the optical head apparatus according to the third exemplary embodiment of the present invention;

FIG. 15 is a diagram showing the configuration of the optical head apparatus according to a fourth exemplary embodiment of the present invention;

FIG. 16 is a cross sectional view of the optical diffraction element in the optical head apparatus according to the fourth exemplary embodiment of the present invention;

FIG. 17 is a diagram showing the configuration of the optical head apparatus according to a fifth exemplary embodiment of the present invention;

FIG. 18 is a cross sectional view of the optical diffraction element in the optical head apparatus according to the fifth exemplary embodiment of the present invention;

FIG. 19 is a diagram showing the configuration of the optical head apparatus according to a sixth exemplary embodiment of the present invention;

FIG. 20 is a cross sectional view of the optical diffraction element in the optical head apparatus according to the sixth exemplary embodiment of the present invention;

FIG. 21 is a diagram showing the configuration of the optical head apparatus according to a seventh exemplary embodiment of the present invention;

FIG. 22 is a diagram showing the configuration of the optical head apparatus according to an eighth exemplary embodiment of the present invention;

FIG. 23 is a cross sectional view of the optical diffraction element in the optical head apparatus according to the eighth exemplary embodiment of the present invention; and

FIG. 24 is a view showing a configuration of an optical information recording/reproducing apparatus according to a ninth exemplary embodiment of the present invention.

### BEST MODE OF CARRYING OUT THE INVENTION

An optical information recording/reproducing apparatus having an optical head apparatus according to exemplary embodiments of the present invention will be described below in detail with reference to the drawings.

### First Exemplary Embodiment

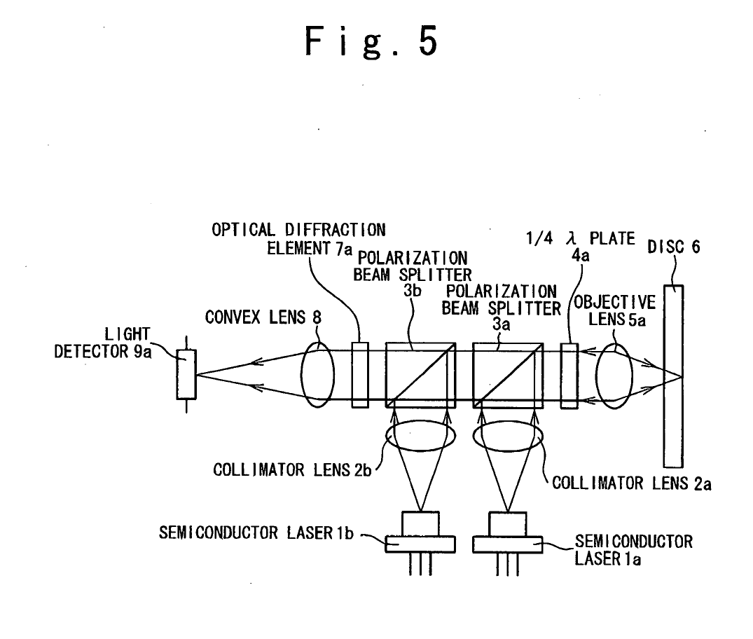

FIG. 5 is a block diagram showing the configuration of the optical head apparatus according to a first exemplary embodiment of the present invention. A semiconductor laser 1a outputs a light beam of the wavelength of 780 nm for a CD standard, and a semiconductor laser 1b outputs a light beam of the wavelength of 650 nm for a DVD standard. The light beam of the wavelength of 650 nm outputted from the semiconductor laser 1b is made parallel by a collimator lens 2b, and is inputted as S polarization to a polarization beam splitter 3b, and then is reflected in a portion for approximate 100%. Subsequently, the reflected light beam is inputted as the S polarization to a polarization beam splitter 3a, transmits the splitter 3a for approximate 100%, and further transmits a ¼ wavelength (λ) plate 4a, is converted from linear polarization into circular polarization, and then is focused onto a disc 6 as an optical recording medium for the DVD standard by an objective lens 5a. The light beam reflected by the disc 6 transmits the objective lens 5a in a direction opposite to the input direction to the disc 6, transmits the ¼ wavelength plate 4a, and is converted from the circular polarization into the linear polarization in which a forward path and the polarization direction are orthogonal. The converted light beam is inputted as P polarization to the polarization beam splitter 3a, transmits the splitter 3a for approximate 100%, and is inputted as the P polarization to the polarization beam splitter 3b, to transmit for approximate 100%. Then, the transmitting light beam is diffracted by an optical diffraction element 7a, transmits a convex lens 8, and then is received by a light detector 9a. The light beam of the wavelength of 780 nm outputted from the semiconductor laser 1a is made parallel by the collimator lens 2a, is inputted as the S polarization to the polarization beam splitter 3a, and is reflected for approximate 100%. Then, the reflected light beam transmits the ¼ wavelength plate 4a, is converted from the linear polarization into the circular polarization, and then is focused onto the disc 6 serving as the optical recording medium for the CD standard by the objective lens 5a. The light beam reflected by the disc 6 transmits the objective lens 5a in a direction opposite to the input direction to the disc 6, transmits the ¼ wavelength plate 4a, and is converted from the circular polarization into the linear polarization in which a direction of the forward path and the polarization direction are orthogonal. Then, the converted light beam is inputted as the P polarization to the polarization beam splitter 3a, transmits for approximate 100%, is inputted as the P polarization to the polarization beam splitter 3b, and transmits the splitter 3b for approximate 100%. Then, the transmitting light beam is diffracted by the optical diffraction element 7a, transmits the convex lens 8, and then is received by the light detector 9a. It should be noted that instead of the polarization beam splitters 3a and 3b, a non-polarization beam splitter can be used.

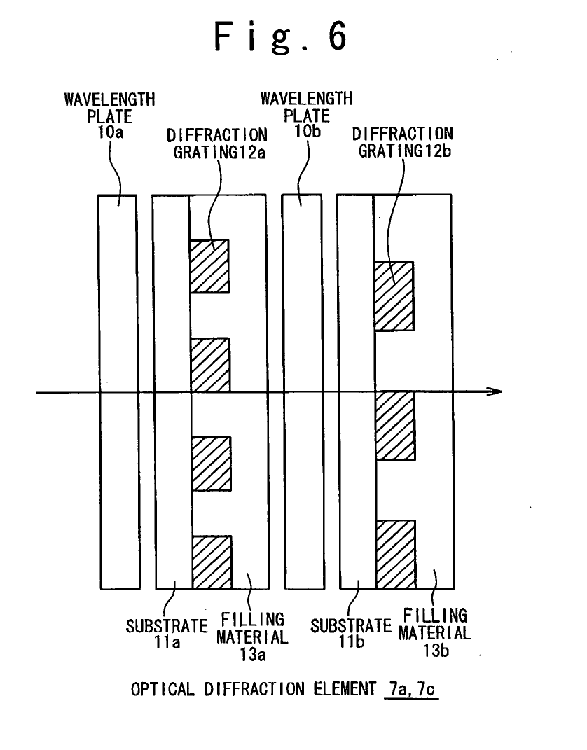

FIG. 6 is a sectional view of the optical diffraction element 7a. The optical diffraction element 7a has a configuration in which a wavelength plate 10a, a diffraction grating 12a, a wavelength plate 10b and a diffraction grating 12b are laminated. As the wavelength plates 10a and 10b, a crystal having a birefringence property can be used, or a member can be used that liquid crystal polymer having the birefringence property is put between glass substrates. The diffraction gratings 12a and 12b are obtained by forming patterns of the liquid crystal polymer having the birefringence property on glass substrates 11a and 11b, and embedding the patterns with filling materials 13a and 13b, respectively. The wavelength plate 10a, the diffraction grating 12a, the wavelength plate 10b and the diffraction grating 12b can be integrated by putting an adhesive agent layer therebetween. Also, instead of the substrates 11a and 11b, the wavelength plates 10a and 10b may be used as the substrates. The sectional structure of the patterns of the liquid crystal polymers in the diffraction gratings 12a and 12b are rectangular, as shown in FIG. 6.

The wavelength plate 10a functions as a full wavelength plate for the light beam of the wavelength of 650 nm and functions as a ½ wavelength plate, which converts a polarization direction of the input light beam by 90°, for the light beam of the wavelength of 780 nm. This can be attained by setting a phase difference caused by the wavelength plate 10a for the input light beam to an integer times of 2π for the light beam of the wavelength of 650 nm and odd-number times of π for the light beam of the wavelength of 780 nm. For example, when the phase difference caused by the wavelength plate 10a is set to 2π/λ×2000 nm (λ is the wavelength of the input light beam), the phase difference in case of λ=650 nm is 2π×3.08, and the phase difference in case of λ=780 nm is π×5.13. Thus, the foregoing condition is substantially satisfied.

The wavelength plate 10b functions as the ½ wavelength plate of a wide range to convert the polarization direction of the input light beam by 90° for each of the light beam of the wavelength of 650 nm and the light beam of the wavelength of 780 nm. The ½ wavelength plate is described in, for example, Japanese Laid Open Patent Application (JP-A-Heisei 5-100114).

The directions of the grooves in the diffraction gratings 12a and 12b are the directions perpendicular to the paper surface of FIG. 6. Here, the linear polarization in which the polarization direction is parallel to the grooves in the diffraction gratings 12a and 12b, namely, the linear polarization perpendicular to the paper surface of FIG. 6 is defined as a TE polarization, and the linear polarization in which the polarization direction is perpendicular to the grooves in the diffraction gratings 12a and 12b, namely, the linear polarization parallel to the paper surface of FIG. 6 is defined as a TM polarization. At this time, the refractive indexes of the liquid crystal polymers and the like in the diffraction gratings 12a and 12b are equal to the refractive index of the filling material for the TE polarization and different from the refractive index of the filling material for the TM polarization.

The light beam of the wavelength of 650 nm for the DVD is inputted as the TM polarization from the left side for the optical diffraction element 7a shown in FIG. 6. This light beam transmits the wavelength plate 10a in its original state of the TM polarization and is inputted to the diffraction grating 12a. Thus, the input light beam is diffracted as the ± primary diffraction light beams by the diffraction grating 12a. The diffraction efficiencies of the ± primary diffraction light beams are defined based on a phase difference by the diffraction grating 12a, and an interval of the ± primary diffraction light beams on the light detector 9a is defined based on a pitch in the diffraction grating 12a. Those light beams transmits the wavelength plate 10b and are converted from the TM polarization into the TE polarization and are inputted to the diffraction grating 12b. Thus, they substantially perfectly transmit the diffraction grating 12b.

The light beam of the wavelength of 780 nm for the CD is similarly inputted as the TM polarization from the left side for the optical diffraction element 7a shown in FIG. 6. The light beam transmits the wavelength plate 10a, is converted from the TM polarization into the TE polarization, and is inputted to the diffraction grating 12a. Thus, the light beam substantially perfectly transmits the diffraction grating 12a. The light beam transmits the wavelength plate 10b and is converted from the TE polarization into the TM polarization, and is inputted to the diffraction grating 12b. Therefore, the light beam is diffracted as the ± primary diffraction light beams by the diffraction grating 12b. The diffraction efficiencies of the ± primary diffraction light beams are defined based on a phase difference by the diffraction grating 12b, and an interval of the ± primary diffraction light beams on the light detector 9a is defined based on a pitch in the diffraction grating 12b.

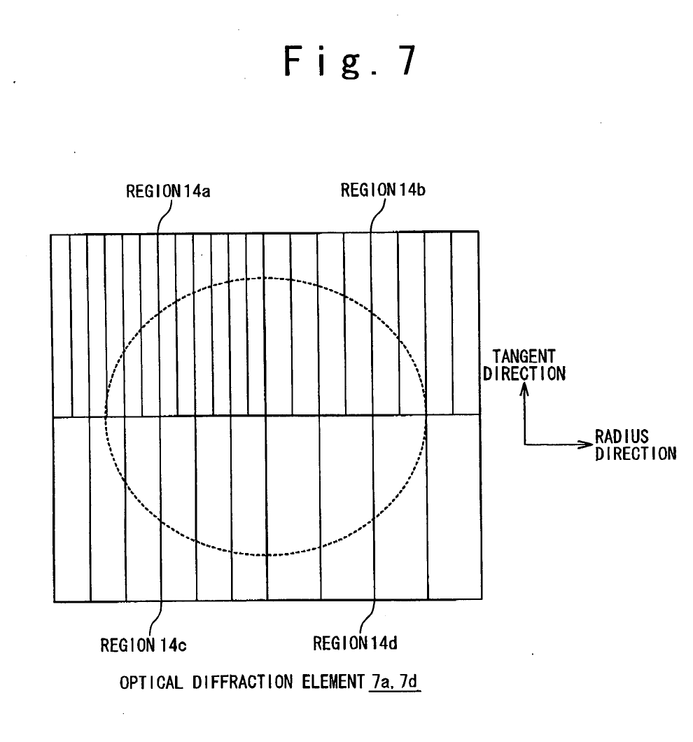

FIG. 7 is a plan view of the optical diffraction element 7a. The optical diffraction element 7a is formed in such a manner that the diffraction gratings are formed into four regions 14a, 14b, 14c and 14d with straight lines passing through the optical axis of the input light beam and parallel to the radius direction of the disc 6 and straight lines parallel to a tangent line direction. All of the directions of the diffraction gratings in the respective regions are parallel to the tangent line direction of the disc 6, and all of the patterns of the diffraction gratings are linear and equal in pitch. The pitches of the diffraction gratings in each of the regions 14a, 14b, 14c and 14d are wider in this order.

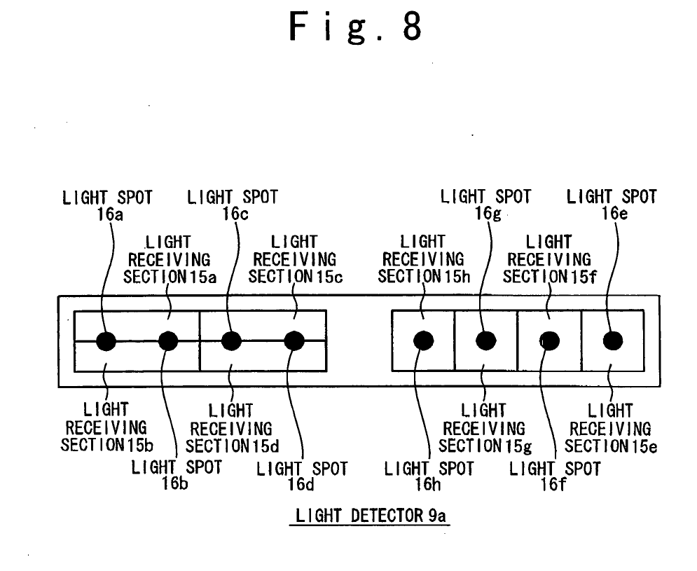

FIG. 8 shows the arrangement of light receiving sections of the light detector 9a and light spots on the light detector 9a. A light spot 16a corresponds to the − primary diffraction light beam from the region 14a of the optical diffraction element 7a and is received by light receiving sections 15a and 15b divided into two by a division line parallel to the radius direction of the disc 6. A light spot 16b corresponds to the − primary diffraction light beam from the region 14b of the optical diffraction element 7a and is received by light receiving sections 15a and 15b divided into two by the division line parallel to the radius direction of the disc 6. A light spot 16c corresponds to the − primary diffraction light beam from the region 14c of the optical diffraction element 7a and is received by light receiving sections 15c and 15d divided into two by the division line parallel to the radius direction of the disc 6. A light spot 16d corresponds to the − primary diffraction light beam from the region 14d of the optical diffraction element 7a and is received by light receiving sections 15c and 15d divided into two by the division line parallel to the radius direction of the disc 6. A light spot 16e corresponds to the + primary diffraction light beam from the region 14a of the optical diffraction element 7a and is received by a single light receiving section 15e. A light spot 16f corresponds to the + primary diffraction light beam from the region 14b of the optical diffraction element 7a and is received by a single light receiving section 15f. A light spot 16g corresponds to the + primary diffraction light beam from the region 14c of the optical diffraction element 7a and is received by a single light receiving section 15g. A light spot 16h corresponds to the + primary diffraction light beam from the region 14d of the optical diffraction element 7a and is received by a single light receiving section 15h.

When the outputs from the light receiving sections 15a to 15h are respectively represented as V15a to V15h, a focus error signal is obtained from the calculation of (V15a+V15d)−(V15b+V15c) by a knife edge method. A track error signal is obtained from the calculation of (V15e+V15g)−(V15f+V15h) by a push-pull method or obtained from the phase difference of (V15e+V15h) and (V15f+V15g) by a phase difference method. An RF signal is obtained from the calculation of (V15e+V15f+V15g+V15h).

In the first exemplary embodiment, the pitches of the regions 14a to 14d in the diffraction grating 12a are defined such that the − primary diffraction light beam of the wavelength of 650 nm generates the light spots 16a to 16d on the light detector 9a, respectively, and the + primary diffraction light beam generates the light spots 16e to 16h on the light detector 9a, respectively. Also, the pitches of the regions 14a to 14d in the diffraction grating 12b are defined such that the − primary diffraction light beam of the wavelength of 780 nm generates the light spots 16a to 16d on the light detector 9a, respectively, and the + primary diffraction light beam generates the light spots 16e to 16h on the light detector 9a, respectively.

In the first exemplary embodiment, it is supposed that the phase difference between a line portion and a space portion of the diffraction grating 12a with respect to the TM polarization light beam is π for the wavelength of 650 nm. At this time, the ± primary diffraction efficiencies of the light beam of the wavelength of 650 nm are 40.5%. Also, it is supposed that the phase difference between the line portion and the space portion of the diffraction grating 12b with respect to the TM polarization light beam is π for the wavelength of 780 nm. At this time, the ± primary diffraction efficiencies of the light beam of the wavelength of 780 nm are 40.5%.

The functions of the wavelength plates 10a and 10b in the first exemplary embodiment are not always required to comply with the description in FIG. 6. It is sufficient that the polarization directions of the light beam of the wavelength of 650 nm and the light beam of the wavelength of 780 nm, which are inputted to the diffraction grating 12a, are orthogonal to each other and the polarization directions of the light beam of the wavelength of 650 nm and the light beam of the wavelength of 780 nm, which are inputted to the diffraction grating 12b, are orthogonal to each other. The wavelength plates 10a and 10b are properly selected from the following three kinds. That is, they are: (1) the wavelength plate that functions as the ½ waveform plate for converting the polarization direction of the input light beam by 90° for the light beam of the wavelength of 650 nm and functions as the full wavelength plate for the light beam of the wavelength of 780 nm; (2) the wavelength plate that functions as the full wavelength plate for the light beam of the wavelength of 650 nm and functions as the ½ waveform plate for converting the polarization direction of the input light beam by 90° for the light beam of the wavelength of 780 nm; and (3) the wavelength plate that functions as the ½ waveform plate of the wide band for converting the polarization direction of the input light beam by 90° for the light beam of the wavelength of 650 nm and the light beam of the wavelength of 780 nm. Also, the wavelength plates 10a and 10b may be properly removed.

The functions of the diffraction gratings 12a and 12b in the first exemplary embodiment are not always required to comply with the description in FIG. 6. The diffraction grating 12a may diffract any one of the light beam of the wavelength of 650 nm and the light beam of the wavelength of 780 nm as the ± primary diffraction light beams and substantially perfectly transmit the other light beam. The diffraction grating 12b may diffract the other light beam that is not diffracted by the diffraction grating 12a, of the light beam of the wavelength of 650 nm and the light beam of the wavelength of 780 nm and substantially perfectly transmit the other light beam. The diffraction gratings 12a and 12b are properly selected from the two kinds of (1) the diffraction grating in which the refractive index of the liquid crystal polymer is equal to the refractive index of the filling material for the polarization parallel to the optical axis and different from the refractive index of the filling material for the polarization perpendicular to the optical axis; and (2) the diffraction grating in which the refractive index of the liquid crystal polymer is different from the refractive index of the filling material for the polarization parallel to the optical axis and equal to the refractive index of the filling material for the polarization perpendicular to the optical axis. Here, the polarization parallel to the optical axis and the polarization orthogonal to the optical axis are not required to coincide with the TE polarization and the TM polarization, respectively.

### Second Exemplary Embodiment

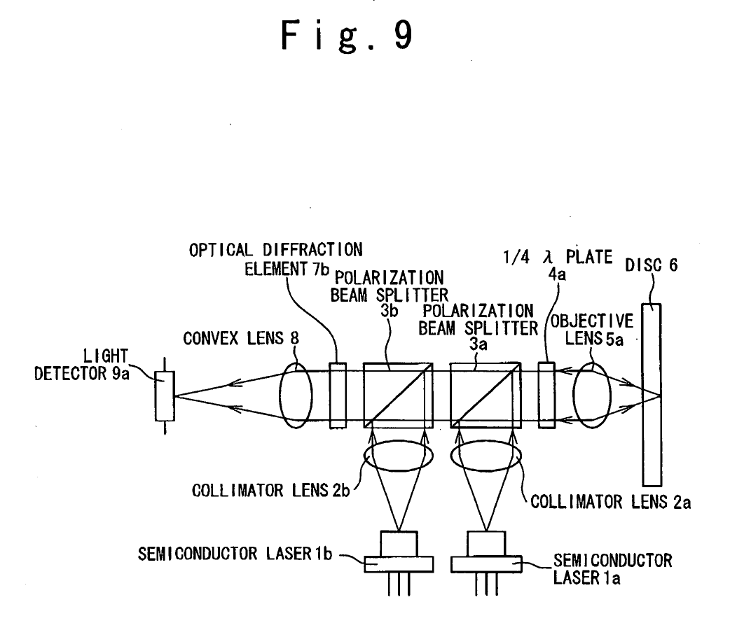

FIG. 9 shows the configuration of the optical head apparatus according to the second exemplary embodiment of the present invention. In the second exemplary embodiment, the optical diffraction element 7a in the first exemplary embodiment is replaced by an optical diffraction element 7b.

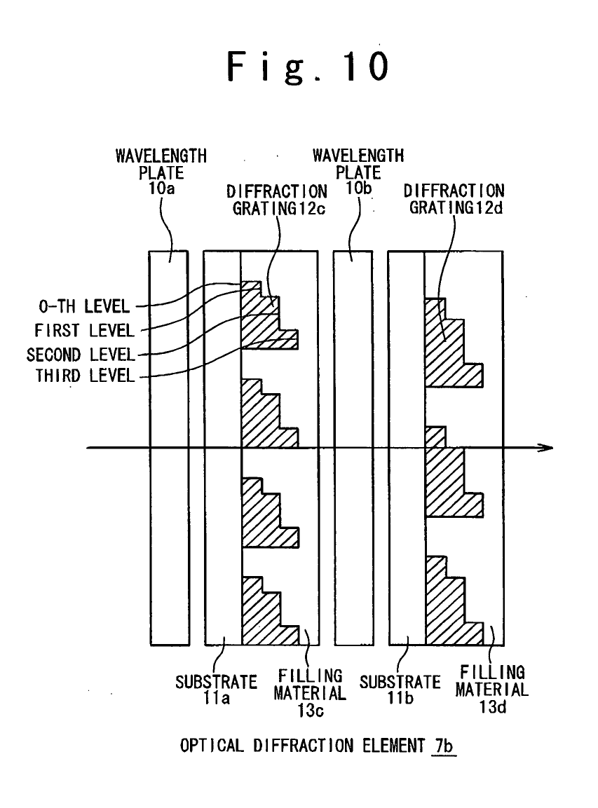

FIG. 10 is a sectional view of the optical diffraction element 7b. The optical diffraction element 7b has a configuration in which the wavelength plate 10a, the diffraction grating 12c, the wavelength plate 10b and the diffraction grating 12d are laminated. As the wavelength plates 10a and 10b, crystals having birefringence property can be used, or a member in which the liquid crystal polymer having the birefringence property is sandwiched with the glass substrates can be used. The diffraction gratings 12c and 12d are such that the patterns of the liquid crystal polymer having the birefringence property are formed on the glass substrates 11a and 11b, respectively, and they are embedded with the filling materials 13a and 13b, respectively. The wavelength plate 10a, the diffraction grating 12c, the wavelength plate 10b and the diffraction grating 12d can be integrated with the adhesive layers therebetween. Also, instead of the substrates 11a and 11b, the wavelength plates 10a and 10b can be also used as the substrates. The sectional structure of the patterns of the liquid crystal polymers in the diffraction gratings 12c and 12d is a step manner. The diffraction gratings 12c and 12d shown in FIG. 10 have the stepped configuration of a total of 4 levels composed of a 0-th level, a first level, a second level and a third level.

The wavelength plate 10a functions as the full wavelength plate for the light bean of the wavelength of 650 nm and functions as the ½ wavelength plate, which converts the polarization direction of the input light beam by 90°, for the light beam of the wavelength of 780 nm. This can be attained by setting the phase difference of the wavelength plate 10a at the integer times of 2π for the light beam of the wavelength of 650 nm and at the odd-number times of π for the light beam of the wavelength of 780 nm. For example, when the phase difference due to the wavelength plate 10a is set at 2π/λ×2000 nm (λ is the wavelength of the input light beam), the phase difference in case of λ=650 nm is 2π×3.08, and the phase difference in case of λ=780 nm is π×5.13. Thus, the foregoing condition is substantially satisfied.

The wavelength plate 10b functions as the ½ wavelength plate of a wide range to convert the polarization direction of the input light beam by 90° for each of the light beam of the wavelength of 650 nm and the light beam of the wavelength of 780 nm. Such ½ wavelength plate of the wide range is described in Japanese Laid Open Patent Application (JP-A-Heisei, 5-100114).

The direction of the grooves in the diffraction gratings 12c and 12d is a direction perpendicular to the paper surface of FIG. 10. Here, the linear polarization in which the polarization direction is parallel to the direction of the grooves in the diffraction gratings 12c and 12d, namely, the linear polarization perpendicular to the paper surface of FIG. 10 is defined as the TE polarization, and the linear polarization in which the polarization direction is perpendicular to the direction of the grooves in the diffraction gratings 12c and 12d, namely, the linear polarization parallel to the paper surface of FIG. 10 is defined as the TM polarization. At this time, the refractive index of the liquid crystal polymer in the diffraction gratings 12c and 12d is equal to the refractive index of the filling material for the TE polarization and different from the refractive index of the filling material for the TM polarization.

The light beam of the wavelength of 650 nm for the DVD is inputted as the TM polarization light beam from the left side for the optical diffraction element 7b shown in FIG. 10. This light beam transmits the wavelength plate 10a in its original state of the TM polarization and inputted to the diffraction grating 12c. Thus, this light beam is diffracted to the ± primary diffraction light beams by the diffraction grating 12c. The diffraction efficiencies of the ± primary diffraction light beams are defined based on the phase difference of the diffraction grating 12c, and the width of each level, and an interval of the ± primary diffraction light beams on the light detector 9a is defined as a pitch in the diffraction grating 12c. Those light beams transmit the wavelength plate 10b, are converted from the TM polarization light beams into the TE polarization light beams, and are inputted to the diffraction grating 12d. Thus, the light beams substantially perfectly transmit the diffraction grating 12d.

The light beam of the wavelength of 780 nm for the CD is similarly inputted as the TM polarization light beam from the left side for the optical diffraction element 7b shown in FIG. 10. This light beam transmits the wavelength plate 10a, is converted from the TM polarization light beam into the TE polarization light beam, and is inputted to the diffraction grating 12c. Thus, the light beam substantially perfectly transmits the diffraction grating 12c. This light beam transmits the wavelength plate 10b, is converted from the TE polarization light beam into the TM polarization light beam, and is inputted to the diffraction grating 12d. Therefore, this light beam is diffracted to the ± primary diffraction light beams by the diffraction grating 12d. The diffraction efficiencies of the ± primary diffraction light beams are defined based on the phase difference of the diffraction grating 12b and the width of each level, and an interval of the ± primary diffraction light beams is defined as a pitch in the diffraction grating 12d on the light detector 9a.

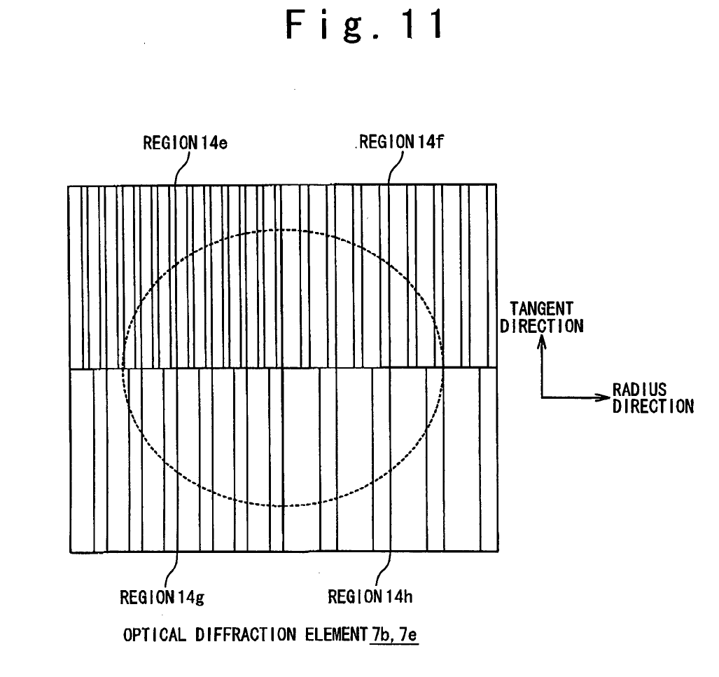

FIG. 11 is a plan view of the optical diffraction element 7b. In the optical diffraction element 7b, a region of the diffraction grating is divided into four regions 14e, 14f, 14g and 14h by a straight line extending in a direction passing through the optical axis of the input light beam and in parallel to the radius direction of the disc 6; and a straight line extending in parallel to the tangent line direction. The direction of the diffraction grating in the each region is parallel to the tangent line direction of the disc 6, and a pattern of the diffraction grating is composed of straight lines which are equal in pitch. The pitches of the respective diffraction gratings in the regions 14e, 14f, 14g and 14h are wider in this order.

A pattern of the light receiving sections of the light detector 9a and an arrangement of the light spots on the light detector 9a in the second exemplary embodiment is same as those shown in FIG. 8. In the second exemplary embodiment, a method similar to the method having been described in the first exemplary embodiment is employed to obtain a focus error signal, a track error signal and an RF signal.

In the second exemplary embodiment, the pitches in the regions 14e to 14h of the diffraction grating 12c are defined such that the − primary diffraction light beam of the wavelength of 650 nm generates the light spots 16a to 16d on the light detector 9a, respectively, and the + primary diffraction light beam generates the light spots 16e to 16h on the light detector 9a, respectively. Also, the pitches in the regions 14e to 14h of the diffraction grating 12d are defined such that the − primary diffraction light beam of the wavelength of 780 nm generates the light spots 16a to 16d on the light detector 9a, respectively, and the + primary diffraction light beam generates the light spots 16e to 16h on the light detector 9a, respectively.

In the second exemplary embodiment, the phase difference between adjacent levels with regard to the TM polarization light beam in the diffraction grating 12c is assumed to be π/2 for the wavelength of 650 nm. Moreover, the widths of the 0-th level and the second level are assumed to be wider or narrower than the widths of the first level and the third level. At this time, for example, the − primary diffraction efficiency of the light beam of the wavelength of 650 nm can be assumed to be 9%, and the + primary diffraction efficiency can be assumed to be 72%. Also, the phase difference between the adjacent levels with regard to the TM polarization light beam of the diffraction grating 12d is assumed to be π/2 for the wavelength of 780 nm. Moreover, the widths of the 0-th level and the second level are assumed to be wider or narrower than the widths of the first level and the third level. At this time, for example, the − primary diffraction efficiency of the light beam of the wavelength of 780 nm can be assumed to be 9%, and the + primary diffraction efficiency can be assumed to be 72%. According to this exemplary embodiment, the diffraction efficiency of the + primary diffraction light beam used to detect the RF signal can be increased, thereby increasing a signal to noise ratio in the RF signal.

The functions of the wavelength plates 10a and 10b in the second exemplary embodiment are not always required to comply with the description in FIG. 10, because of the reason similar to the reason described in the first exemplary embodiment. Also, the functions of the diffraction gratings 12c and 12d in this exemplary embodiment are not always required to comply with the description in FIG. 10, because of the reason similar to the reason described in the first exemplary embodiment.

### Third Exemplary Embodiment

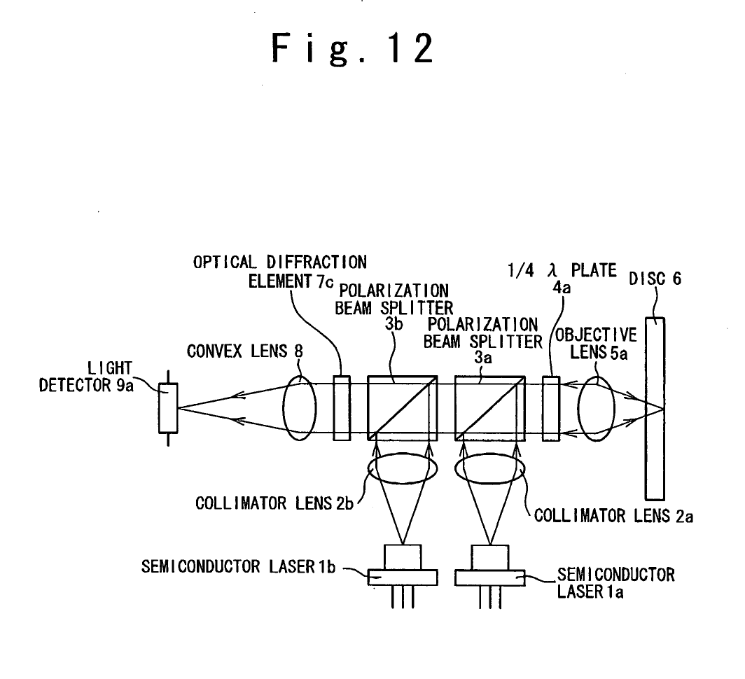

FIG. 12 shows the configuration of the optical head apparatus in the third exemplary embodiment of the present invention. In the third exemplary embodiment, the optical diffraction element 7a in the first exemplary embodiment is replaced by an optical diffraction element 7c, and the light detector 9a is replaced by a light detector 9b. The sectional view of the optical diffraction element 7c in this exemplary embodiment is same as that shown in FIG. 6.

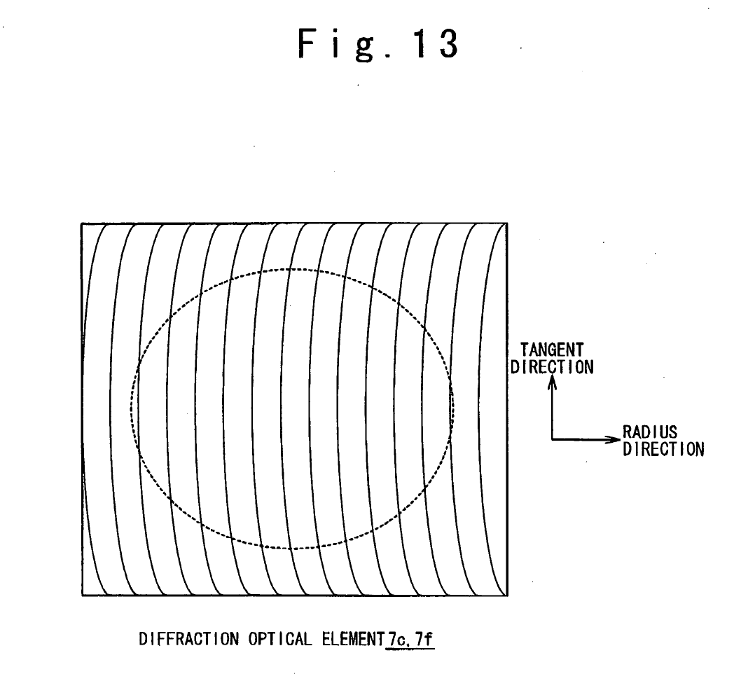

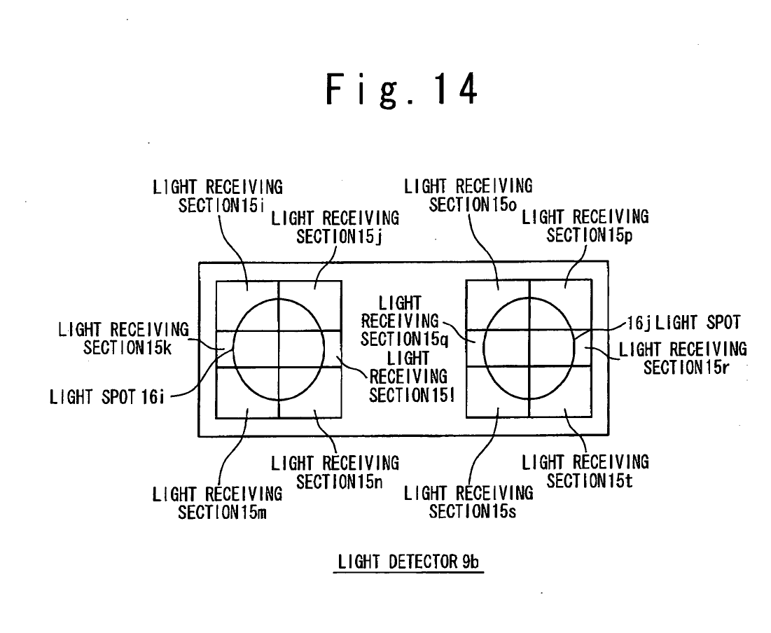

FIG. 13 is a plan view of the optical diffraction element 7c. The optical diffraction element 7c is configured such that the diffraction grating is formed on the entire portion. The direction of the diffraction grating is substantially parallel to the tangent line direction of the disc 6. The pattern of the diffraction grating is concentric. When the light beam is inputted to the optical diffraction element 7c perpendicularly to the paper surface of FIG. 14, the light beam diffracted to the left side of FIG. 14 is referred to as the − primary diffraction light beam, and the light beam diffracted to the right side of FIG. 14 is referred to as the + primary diffraction light beam. At this time, the optical diffraction element 7c functions as the concave lens for the − primary diffraction light beam and functions as the convex lens for the + primary diffraction light beam.

FIG. 14 shows a pattern of the light receiving sections of the light detector 9b and the arrangement of the light spots on the light detector 9b. The light spot 16i corresponds to the − primary diffraction light beam from the optical diffraction element 7c and is received by six light receiving sections 15i to 15n, which are divided by two division lines parallel to the radius direction of the disc 6 and a division line parallel to the tangent line direction. The light spot 16j corresponds to the + primary diffraction light beam from the optical diffraction element 7c and is received by six light receiving sections 15o to 15t, which are divided by the two division lines parallel to the radius direction of the disc 6 and the division line parallel to the tangent line direction.

When the outputs from the light receiving sections 15i to 15t are represented by V15i to V15t, a focus error signal is obtained through the calculation of (V15i+V15j+V15m+V15n+V15q+V15r)−(V15k+V15l+V15o+V15p+V15s+V15t) by a spot size method. A track error signal is obtained through the calculation of (V15i+V15k+V15m+V15p+V15r+V15t)−(V15j+V15l+V15n+V15o+V15q+V15s) by a push-pull method or obtained from the phase difference between (V15i+V15n+V15o+V15t) and (V15j+V15m+V15p+V15s) by a phase difference method. The RF signal is obtained from the calculation of (V15i+V15j+V15k+V15l+V15m+V15n+V15o+V15p+V15q+V15r+V15s+V15t).

In the third exemplary embodiment, the pitch in the diffraction grating 12a is defined such that the − primary diffraction light beam of the wavelength of 650 nm generates the light spot 16i on the light detector 9b and the + primary diffraction light beam generates the light spot 16j on the light detector 9b. Also, the pitch in the diffraction grating 12b is defined such that the − primary diffraction light beam of the wavelength of 780 nm generates the light spot 16i on the light detector 9b and the + primary diffraction light beam generates the light spot 16j on the light detector 9b.

In the third exemplary embodiment, it is supposed that the phase difference between a line portion and a space portion of the diffraction grating 12a with respect to the TM polarization light beam is π for the wavelength of 650 nm. At this time, the ± primary diffraction efficiencies of the light beam of the wavelength of 650 nm are respective 40.5%. Also, it is supposed that the phase difference between the line portion and the space portion of the diffraction grating 12b with respect to the TM polarization light beam is π for the wavelength of 780 nm. At this time, the ± primary diffraction efficiencies of the light beam of the wavelength of 780 nm are respective 40.5%.

The functions of the wavelength plates 10a and 10b in the third exemplary embodiment are not always required to comply with the description in FIG. 6, because of the reason similar to the reason described in the first exemplary embodiment. Also, the functions of the diffraction gratings 12a and 12b in this exemplary embodiment are not always required to comply with the description in FIG. 6, because of the reason similar to the reason described in the first exemplary embodiment.

### Fourth Exemplary Embodiment

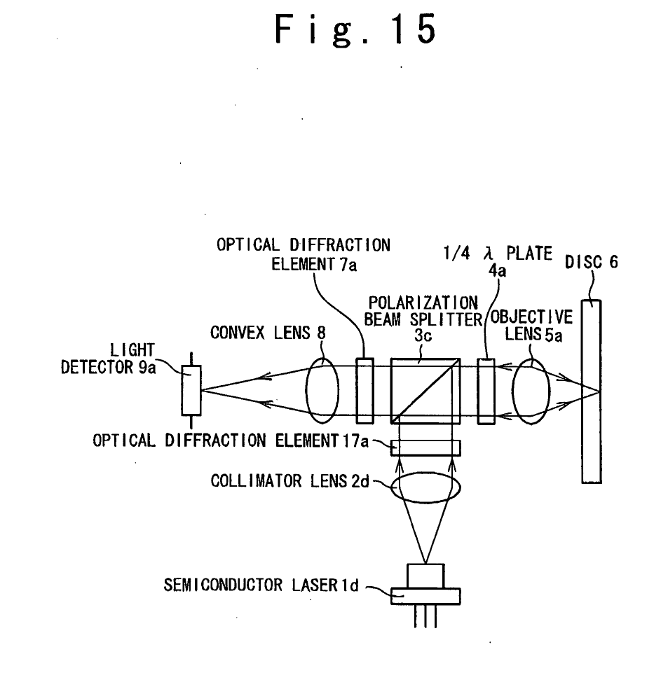

FIG. 15 shows the configuration of the optical head apparatus according to the fourth exemplary embodiment of the present invention. In the semiconductor laser 1d in the fourth exemplary embodiment, the semiconductor laser for outputting the light beam of the wavelength of 650 nm for the DVD according to the first exemplary embodiment and the semiconductor laser for outputting the light beam of the wavelength of 780 nm for the CD are stored in a common package. The light beam of the wavelength of 650 nm outputted from the semiconductor laser 1d is converted into a parallel light beam by the collimator lens 2d, transmits an optical diffraction element 17a, is inputted as the S polarization to the polarization beam splitter 3c, and approximately 100% is reflected. The reflected light beam by the splitter 3c transmits the ¼ wavelength plate 4a and is converted from the linear polarization into the circular polarization, and then collected onto the disc 6 serving as the optical recording medium based on the DVD standard by the objective lens 5a. The light bream reflected by the disc 6 transmits the objective lens 5a in a direction opposite to the input direction to the disc 6, transmits the ¼ wavelength plate 4a, and is converted from the circular polarization into the linear polarization in which a forwarding direction and the polarization direction are orthogonal to each other. The converted light beam is inputted as the P polarization to the polarization beam splitter 3c, transmits for approximate 100%. The transmitting light beam is diffracted by the optical diffraction element 7a, transmits the convex lens 8 and is then received by the light detector 9a. The light beam of the wavelength of 780 nm outputted from the semiconductor laser 1d is converted into a parallel light beam by the collimator lens 2d, is diffracted by the optical diffraction element 17a, and inputted as the S polarization to the polarization beam splitter 3c, and is reflected for approximate 100%. The reflected light beam by the splitter 3c transmits the ¼ wavelength plate 4a, is converted from the linear polarization into the circular polarization and then collected onto the disc 6 serving as the optical recording medium based on the CD standard by the objective lens 5a. The light beam reflected by the disc 6 transmits the objective lens 5a in a direction opposite to the input direction to the disc 6, transmits the ¼ wavelength plate 4a and is converted from the circular polarization into the linear polarization, in which the forward path direction and the polarization direction are orthogonal. The converted light beam is inputted as the P polarization to the polarization beam splitter 3c, transmits for approximate 100%, is diffracted by the optical diffraction element 7a, and transmits the convex lens 8, and is then received by the light detector 9a.

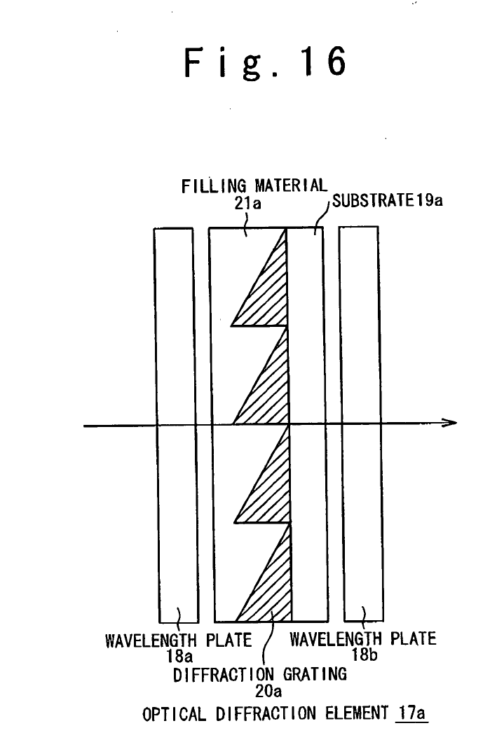

FIG. 16 is a sectional view of the optical diffraction element 17a. The optical diffraction element 17a is formed by laminating a wavelength plate 18a, a diffraction grating 20a and a wavelength plate 18b. As the wavelength plates 18a and 18b, crystals having the birefringence property can be used, or a member can be used in which the liquid crystal polymer having the birefringence property is sandwiched by glass substrates. The diffraction grating 20a is such that a pattern of the liquid crystal polymer having the birefringence property is formed on a substrate 19a of glass, and it is embedded with a filling material 21a. The wavelength plate 18a, the diffraction grating 20a and the wavelength plate 18b can be integrated with adhesive therebetween. Also, instead of the substrate 19a, the wavelength plate 18b can be also used as the substrate. The flat surface shape of the pattern of the liquid crystal polymer in the diffraction grating 20a has a shape of the straight lines of a same pitch, and the sectional shape has the shape of saw teeth.

The wavelength plates 18a and 18b function as the full wavelength plate for the light beam of the wavelength of 650 nm and function as the ½ wavelength plate, which converts the polarization direction of the input light beam by 90°, for the light beam of the wavelength of 780 nm. The direction of the groove in the diffraction grating 20a is a direction perpendicular to the paper surface of FIG. 16. Here, the linear polarization in which the polarization direction is parallel to the groove in the diffraction grating 20a, namely, the linear polarization perpendicular to the paper surface of FIG. 16 is defined as the TE polarization, and the linear polarization in which the polarization direction is perpendicular to the groove in the diffraction grating 20a, namely, the linear polarization parallel to the paper surface of FIG. 16 is defined as the TM polarization. At this time, the refractive index of the liquid crystal polymer in the diffraction grating 20a is equal to the refractive index of the filling material for the TE polarization and different from the refractive index of the filling material for the TM polarization.

The light beam of the wavelength of 650 nm for the DVD is inputted as the TM polarization from the left side for the optical diffraction element 17a shown in FIG. 16. This light beam transmits the wavelength plate 18a in its original state of the TM polarization and is inputted to the diffraction grating 20a. Thus, this substantially perfectly transmits the diffraction grating 20a. This light beam transmits the wavelength plate 18b in its original state of the TE polarization and is outputted as the TE polarization from the optical diffraction element 17a. The light beam of the wavelength of 780 nm for the CD is similarly inputted as the TE polarization from the left side for the optical diffraction element 17a shown in FIG. 16. This light beam transmits the wavelength plate 18a, is converted from the TE polarization into the TM polarization, and is inputted to the diffraction grating 20a. Thus, this light beam is substantially perfectly diffracted to the primary diffraction light beams by the diffraction grating 20a. This light beam transmits the wavelength plate 18b, is converted from the TM polarization into the TE polarization, and is outputted as the TE polarization from the optical diffraction element 17a.

If the light emission point of the semiconductor laser built in the semiconductor laser 1d for the DVD that is coincident with the optical axis of the objective lens 5a, the light emission point of the semiconductor laser built in the semiconductor laser 1d for the CD that is displaced from the optical axis of the objective lens 5a. At this time, since the orientation and pitch of the saw teeth of the diffraction grating 20a are suitably defined on the basis of the orientations of the light emission points of the semiconductor lasers for the DVD and the CD and a displacement of the pitch, the apparent light emission point of the semiconductor laser for the CD can be made coincident with the optical axis of the objective lens 5a. The phase difference of the diffraction grating 20a is defined so as to maximum the diffraction efficiency of the primary diffraction light beam.

The sectional view of the optical diffraction element 7a in the fourth exemplary embodiment is same as that shown in FIG. 6. The plan view of the optical diffraction element 7a in this exemplary embodiment is same as that shown in FIG. 7. The arrangement of the light receiving sections in the light detector 9a and a pattern of the light spots on the light detector 9a are same as those shown in FIG. 8. In this exemplary embodiment, the method similar to the method described in the first exemplary embodiment is used to obtain a focus error signal, a track error signal and a RF signal. In this exemplary embodiment, the method similar to the method described in the first exemplary embodiment is used to define the pitches and phase differences of the diffraction gratings 12a and 12b.

The functions of the wavelength plates 10a and 10b in the fourth exemplary embodiment are not always required to comply with the description in FIG. 6 because of the reason similar to the reason described in the first exemplary embodiment. Also, the functions of the diffraction gratings 12a and 12b in this exemplary embodiment are not always required to comply with the description in FIG. 6 because of the reason similar to the reason described in the first exemplary embodiment.

As the exemplary embodiment of the optical head apparatus of the present invention, this exemplary embodiment may be employed in which the optical diffraction element 7a in the fourth exemplary embodiment is replaced by the optical diffraction element 7b. Also, the exemplary embodiment may be employed in which the optical diffraction element 7a in the fourth exemplary embodiment is displaced by the optical diffraction element 7c and in which the light detector 9a is replaced by the light detector 9b.

### Fifth Exemplary Embodiment

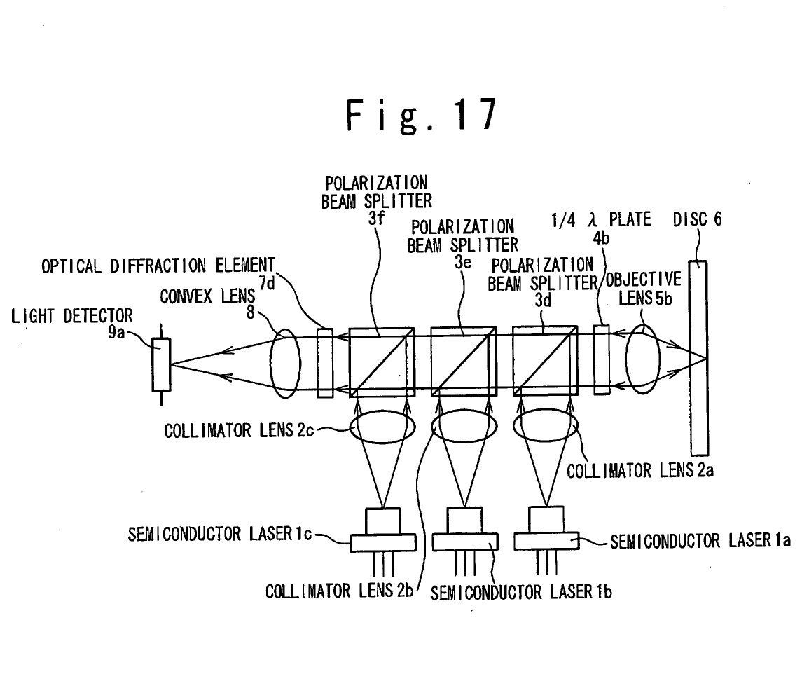

FIG. 17 shows the optical head apparatus according to the fifth exemplary embodiment. The optical head apparatus in the fifth exemplary embodiment further contains a semiconductor laser 1c for HD DVD, a collimator lens 2c and a polarization beam splitter 3f, in addition to the first exemplary embodiment. Also, the optical head apparatus contains an optical diffraction element 7d instead of the optical diffraction element 7a. The semiconductor laser 1a emits the light beam of the wavelength of 780 nm for the CD, the semiconductor laser 1b emits the light beam of the wavelength of 650 nm for the DVD, and the semiconductor laser 1c emits the light beam of the wavelength of 400 nm for the HD DVD. The light beam of the wavelength 400 nm emitted from the semiconductor laser 1c is converted into a parallel light beam by the collimator lens 2c, is inputted as the S polarization to the polarization beam splitter 3f, and is reflected for approximate 100%. The reflected light beam by the splitter 3f is inputted as the S polarization to a polarization beam splitter 3e, transmits for approximate 100%, is inputted as the S polarization to the polarization beam splitter 3d, and transmits for approximate 100%. Then, the transmitting light beam transmits a ¼ wavelength plate 4b, is converted from the linear polarization into the circular polarization, and then is collected onto the disc 6 serving as the optical recording medium based on a HD DVD standard. The light beam reflected by the disc 6 transmits an objective lens 5b in a direction opposite to the input direction to the disc 6, transmits the ¼ wavelength plate 4b, and is converted from the circular polarization into the linear polarization in which the forward path direction and the polarization direction are orthogonal. The converted light beam is inputted as the P polarization to the polarization beam splitter 3d, transmits for approximate 100%, is inputted as the P polarization to the polarization beam splitter 3e, transmits for approximate 100% and is inputted as the P polarization to the polarization beam splitter 3f. The inputted light beam transmits for approximate 100%, is diffracted by the optical diffraction element 7d, transmits the convex lens 8 and is then received by the light detector 9a.

The light beam of the wavelength of 650 nm outputted from the semiconductor laser 1b is converted into a parallel light beam by the collimator lens 2b, is inputted as the S polarization to the polarization beam splitter 3e, and is reflected for approximate 100%. The reflected light beam by the splitter 3e is inputted as the S polarization to the polarization beam splitter 3d, transmits for approximate 100%, transmits the ¼ wavelength plate 4b, and is converted from the linear polarization to the circular polarization. The converted light beam is then collected onto the disc 6 serving as the optical recording medium based on the DVD standard by the objective lens 5b. The light beam reflected by the disc 6 transmits the objective lens 5b in a direction opposite to the input direction to the disc 6, transmits the ¼ wavelength plate 4b, and is converted from the circular polarization to the linear polarization in which the forward path direction and the polarization direction are orthogonal. The converted light beam is inputted as the P polarization to the polarization bean splitter 3d, transmits for approximate 100% and inputted as the P polarization to the polarization beam splitter 3f. The inputted light beam transmits for approximate 100%, is diffracted by the optical diffraction element 7d, transmits the convex lens 8, and is then received by the light detector 9a.

The light beam of the wavelength of 780 nm outputted from the semiconductor laser 1a is converted into a parallel light beam by the collimator lens 2a, is inputted as the S polarization to the polarization beam splitter 3d, and is reflected for approximate 100%. The reflected light beam transmits the ¼ wavelength plate 4b, is converted from the linear polarization into the circular polarization and is then collected onto the disc 6 serving as the optical recording medium based on the CD standard by the objective lens 5b. The light beam reflected by the disc 6 transmits the objective lens 5b in a direction opposite to the input direction to the disc 6, transmits the ¼ wavelength plate 4b, and is converted from the circular polarization into the linear polarization in which the forward path direction and the polarization direction are orthogonal. The converted light beam is inputted as the P polarization to the polarization beam splitter 3d, transmits for approximate 100%, is inputted as the P polarization to the polarization beam splitter 3e, and transmits for approximate 100%. The transmitting light beams is inputted as the P polarization to the polarization beam splitter 3f, transmits for approximate 100%, is diffracted by the optical diffraction element 7d, transmits the convex lens 8, and is then received by the light detector 9a. It should be noted that instead of the polarization beam splitters 3d, 3e and 3f, a non-polarization beam splitter can be used.

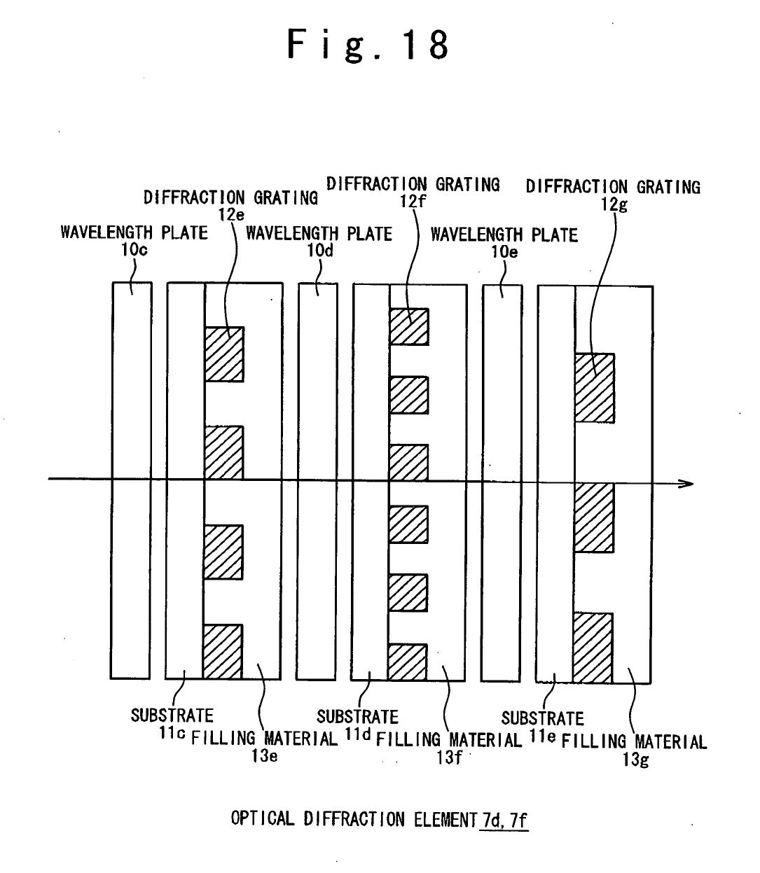

FIG. 18 is a sectional view of the optical diffraction element 7d. The optical diffraction element 7d is formed by laminating a wavelength plate 10c, a diffraction grating 12e, a wavelength plate 10d, a diffraction grating 12f, a wavelength plate 10e and a diffraction grating 12g. As the wavelength plates 10c, 10d and 10e, crystals having the birefringence property can be used, or a member can be used in which the liquid crystal polymer having the birefringence property is sandwiched by glass substrates. The diffraction gratings 12e, 12f and 12g are such that patterns of the liquid crystal polymers having the birefringence property are formed on glass substrates 11c, 11d and 11e, respectively, and they are embedded with filling materials 13e, 13f and 13g, respectively. The wavelength plate 10c, the diffraction grating 12e, the wavelength plate 10d, the diffraction grating 12f, the wavelength plate 10e and the diffraction grating 12g can be integrated with adhesive layers therebetween. Also, instead of the substrates 11c, 11d and 11e, the wavelength plates 10c, 10d and 10e can be also used as the substrates. The sectional structures of the patterns of the liquid crystal polymer in the diffraction gratings 12e, 12f and 12g are rectangular.

The wavelength plates 10c 10e function as full wavelength plates for the light beam of the wavelength 400 nm, function as ½ waveform plates for converting the polarization direction of the input light beam by 90° for the wavelength of 650 nm, and function as full wavelength plates for the light beam of the wavelength of 780 nm. This can be attained by setting the phase difference due to the wavelength plates 10c and 10e to integer times of 2π for the light beam of the wavelength 400 nm, odd-number times of π for the light beam of the wavelength of 650 nm, and integer times of 2π for the light beam of the wavelength of 780 nm. For example, when the phase differences due to the wavelength plates 10c and 10e are set to 2π/λ×1600 nm (λ is the wavelength of the input light beam), the phase difference is 2π×4 in case of λ=400 nm, and the phase difference is π×4.92 in case of λ=650 nm, and the phase difference is 2π×2.05 in case of λ=780 nm. Thus, the foregoing condition is substantially satisfied.

The wavelength plate 10d functions as a full wavelength plate for the light beam of the wavelength 400 nm, functions as a full waveform plate for the light beam of the wavelength of 650 nm, and functions as a ½ waveform plate for converting the polarization direction of the input light beam by 90° for the light beam of the wavelength of 780 nm. This can be attained by setting the phase difference due to the wavelength plate 10d to integer times of 2π for the light beam of the wavelength 400 nm, integer times of 2π for the light beam of the wavelength of 650 nm, and odd-number times of π for the light beam of the wavelength of 780 nm. For example, when the phase difference due to the wavelength plate 10d is set to 2π/λ×2000 nm (λ is the wavelength of the input light beam), the phase difference is 2π×5 in case of λ=400 nm, and the phase difference is 2π×3.08 in case of λ=650 nm, and the phase difference is π×5.13 in case of λ=780 nm. Thus, the foregoing condition is substantially satisfied.

The directions of the grooves in the diffraction gratings 12e, 12f and 12g are perpendicular to the paper surface of FIG. 18. Here, the linear polarization is which the polarization direction is parallel to the directions of the grooves in the diffraction gratings 12e, 12f and 12g, namely, the linear polarization in a direction perpendicular to the paper surface of FIG. 18 is defined as the TE polarization, and the linear polarization in which the polarization direction is perpendicular to directions of the grooves in the diffraction gratings 12e, 12f and 12g, namely, the linear polarization in a direction parallel to the paper surface of FIG. 18 is defined as the TM polarization. At this time, the refractive index of the liquid crystal polymer in the diffraction gratings 12e and 12g is different from the refractive index of the filling material for the TE polarization and equal to the refractive index of the filling material for the TM polarization. Also, the refractive index in the liquid crystal polymer in the diffraction grating 12f is equal to the refractive index of the filling material for the TE polarization and different from the refractive index of the filling material for the TM polarization.

The light beam of the wavelength 400 nm for the HD DVD is inputted as the TM polarization to the optical diffraction element 7d. This light beam transmits the wavelength plate 10c in the original state of the TM polarization and is inputted to the diffraction grating 12e. Thus, this light beam substantially perfectly transmits the diffraction grating 12e. This light beam transmits the wavelength plate 10d in the original state of the TM polarization and is inputted to the diffraction grating 12f. Thus, this light beam is diffracted as the ± primary diffraction light beams by the diffraction grating 12f. The diffraction efficiencies of the ± primary diffraction light beams are defined based on a phase difference of the diffraction grating 12f, and an interval of the ± primary diffraction light beams on the light detector 9a is defined based on a pitch in the diffraction grating 12f. Those light beams are transmitted in the original state of the TM polarization through the wavelength plate 10e and is inputted to the diffraction grating 12g. Therefore, this substantially perfectly transmits the diffraction grating 12g.

The light beam of the wavelength of 650 nm for the DVD is inputted as the TM polarization to the optical diffraction element 7d. This light beam transmits the wavelength plate 10c, is converted from the TM polarization into the TE polarization, and is then inputted to the diffraction grating 12e. Thus, this light beam is diffracted to the ± primary diffraction light beams by the diffraction grating 12e. The diffraction efficiency to the ± primary diffraction light beams is defined based on a phase difference of the diffraction grating 12e, and an interval of the ± primary diffraction light beams on the light detector 9a is defined based on a pitch in the diffraction grating 12e. Those light beams transmit the wavelength plate 10d in its original state of the TE polarization and are inputted to the diffraction grating 12f. Thus, they substantially perfectly transmits the diffraction grating 12f. Those light beams transmit the wavelength plate 10e, are converted from the TE polarization beams into the TM polarization beams, and are then inputted to the diffraction grating 12g. Therefore, they are substantially perfectly transmits the 12g.

The light beam of the wavelength of 780 nm for the CD is inputted as the TM polarization to the optical diffraction element 7d. This light beam transmits the wavelength plate 10c in its original state of the TE polarization, and is inputted to the diffraction grating 12e. Thus, this light beam substantially perfectly transmits the diffraction grating 12e. This light beam transmits the wavelength plate 10d, is converted from the TM polarization into the TE polarization, and is inputted to the diffraction grating 12f. Thus, this light beam substantially perfectly transmits the diffraction grating 12f. This light beam transmit the wavelength plate 10e in its original state of the TE polarization, and is inputted to the diffraction grating 12g. Therefore, this light beam is diffracted to the ± primary diffraction light beams by the diffraction grating 12g. The diffraction efficiency to the ± primary diffraction light beams is defined based on a phase difference of the diffraction grating 12g, and an interval of the ± primary diffraction light beams on the light detector 9a is defined based on a pitch in the diffraction grating 12g.

A plan view of the optical diffraction element 7d in the fifth exemplary embodiment is same as that shown in FIG. 7. In this exemplary embodiment, the arrangement of the light receiving sections in the light detector 9a and a pattern of the light spots on the light detector 9a are same as those shown in FIG. 8. In this exemplary embodiment, the method similar to the method described in the first exemplary embodiment is used to obtain a focus error signal, a track error signal and an RF signal.

In the fifth exemplary embodiment, the pitches in the regions 14a to 14d of the diffraction grating 12f are defined such that the − primary diffraction light beam of the wavelength 400 nm generates the light spots 16a to 16d on the light detector 9a, respectively, and the + primary diffraction light beam generates the light spots 16e to 16h on the light detector 9a, respectively. Also, the pitches in the regions 14a to 14d of the diffraction grating 12e are defined such that the − primary diffraction light beam of the wavelength of 650 nm generates the light spots 16a to 16d on the light detector 9a, respectively, and the + primary diffraction light beam generates the light spots 16e to 16h on the light detector 9a, respectively. Also, the pitches in the regions 14a to 14d of the diffraction grating 12g are defined such that the − primary diffraction light beam of the wavelength of 780 nm generates the light spots 16a to 16d on the light detector 9a, respectively, and the + primary diffraction light beam generates the light spots 16e to 16h on the light detector 9a, respectively.

In the fifth exemplary embodiment, it is supposed that a phase difference between a line portion and a space portion of the diffraction grating 12f with respect to the TM polarization light beam is π for the wavelength 400 nm. At this time, the ± primary diffraction efficiencies of the light beam of the wavelength 400 nm are respective 40.5%. Also, it is supposed that a phase difference between a line portion and a space portion of the diffraction grating 12e with respect to the TE polarization light beam is π for the wavelength of 650 nm. At this time, the ± primary diffraction efficiencies of the light beam of the wavelength of 650 nm are respective 40.5%. Also, it is supposed that a phase difference between a line portion and a space portion of the diffraction grating 12g with respect to the TE polarization light beam is π for the wavelength of 780 nm. At this time, the ± primary diffraction efficiencies of the light beam of the wavelength of 780 nm are respective 40.5%.

The functions of the wavelength plates 10c, 10d and 10e in the fifth exemplary embodiment are not always required to comply with the description in FIG. 18. Among the light beam of the wavelength 400 nm, the light beam of the wavelength of 650 nm and the light beam of the wavelength of 780 nm that are inputted to the diffraction grating 12e, the polarization direction of any one light beam may be orthogonal to the polarization directions of the other two light beams. Among the light beam of the wavelength 400 nm, the light beam of the wavelength of 650 nm and the light beam of the wavelength of 780 nm that are inputted to the diffraction grating 12f, the polarization direction of any one light beam except one light beam whose polarization direction is different from the others in the diffraction grating 12e may be orthogonal to the polarization directions of the other two light beams. Among the light beam of the wavelength 400 nm, the light beam of the wavelength of 650 nm and the light beam of the wavelength of 780 nm that are inputted to the diffraction grating 12g, the polarization direction of the light beam except the two light beams whose polarization directions are different from the other in the diffraction gratings 12e, 12f may be orthogonal to the polarization directions of the other two light beams. Each of the wavelength plates 10c, 10d and 10e is suitably selected from among the six kinds of: (1) the wavelength plate that functions as a ½ waveform plate for converting the polarization direction of the input light beam by 90° for the light beam of the wavelength 400 nm, functions as a full wavelength plate for the light beam of the wavelength of 650 nm and functions as a full wavelength plate for the light beam of the wavelength of 780 nm; (2) a wavelength plate that functions as a full wavelength plate for the light beam of the wavelength 400 nm, functions as a ½ waveform plate for converting the polarization direction of the input light beam by 90° for the light beam of the wavelength of 650 nm and functions as a full wavelength plate for the light beam of the wavelength of 780 nm; (3) a wavelength plate that functions as a full wavelength plate for the light beam of the wavelength 400 nm, functions as a full wavelength plate for the light beam of the wavelength of 650 nm and functions as a ½ waveform plate for converting the polarization direction of the input light beam by 90° for the light beam of the wavelength of 780 nm; (4) a wavelength plate that functions as a full wavelength plate for the light beam of the wavelength 400 nm, functions as a ½ waveform plate for converting the polarization direction of the input light beam by 90° for the light beam of the wavelength of 650 nm and functions as a ½ waveform plate for converting the polarization direction of the input light beam by 90° for the light beam of the wavelength of 780 nm; (5) a wavelength plate that functions as a ½ waveform plate for converting the polarization direction of the input light beam by 90° for the light beam of the wavelength 400 nm, functions as a full wavelength plate for the light beam of the wavelength of 650 nm and functions as a ½ waveform plate for converting the polarization direction of the input light beam by 90° for the light beam of the wavelength of 780 nm; and (6) a wavelength plate that functions as a ½ waveform plate for converting the polarization direction of the input light beam by 90° for the light beam of the wavelength 400 nm, functions as a ½ waveform plate for converting the polarization direction of the input light beam by 90° for the light beam of the wavelength of 650 nm and functions as a full wavelength plate for the light beam of the wavelength of 780 nm. The wavelength plates 10c, 10d and 10e can be properly removed.

The functions of the diffraction gratings 12e, 12f and 12g in the fifth exemplary embodiment are not always required to comply with the description in FIG. 18. The diffraction grating 12e may diffract any one light beam, among the light beam of the wavelength 400 nm, the light beam of the wavelength of 650 nm and the light beam of the wavelength of 780 nm, to the ± primary diffraction light beams, and substantially perfectly transmit the other two light beams. The diffraction grating 12f may diffract any one light beam except one light beam diffracted by the diffraction grating 12e, among the light beam of the wavelength 400 nm, the light beam of the wavelength of 650 nm and the light beam of the wavelength of 780 nm, to the ± primary diffraction light beams, and substantially perfectly transmits the other two light beams. The diffraction grating 12g may diffract the light beam except the two light beams diffracted by the diffraction gratings 12e, 12f, among the light beam of the wavelength 400 nm, the light beam of the wavelength of 650 nm and the light beam of the wavelength of 780 nm, to the ± primary diffraction light beams, and substantially perfectly transmit the other two light beams. The diffraction gratings 12e, 12f and 12g are properly selected from the two kinds of (1) the diffraction grating in which the refractive index of the liquid crystal polymer is same as the refractive index of the filling material for the polarization parallel to the optical axis and different from the refractive index of the filling material for the polarization perpendicular to the optical axis; and (2) the diffraction grating where the refractive index of the liquid crystal polymer is different from the refractive index of the filling material for the polarization in a direction parallel to the optical axis and equal to the refractive index of the filling material for the polarization in a direction perpendicular to the optical axis. Here, the polarization in the direction parallel to the optical axis and the polarization in the direction perpendicular to the optical axis may not be coincident with the TE polarization and the TM polarization, respectively.

### Sixth Exemplary Embodiment

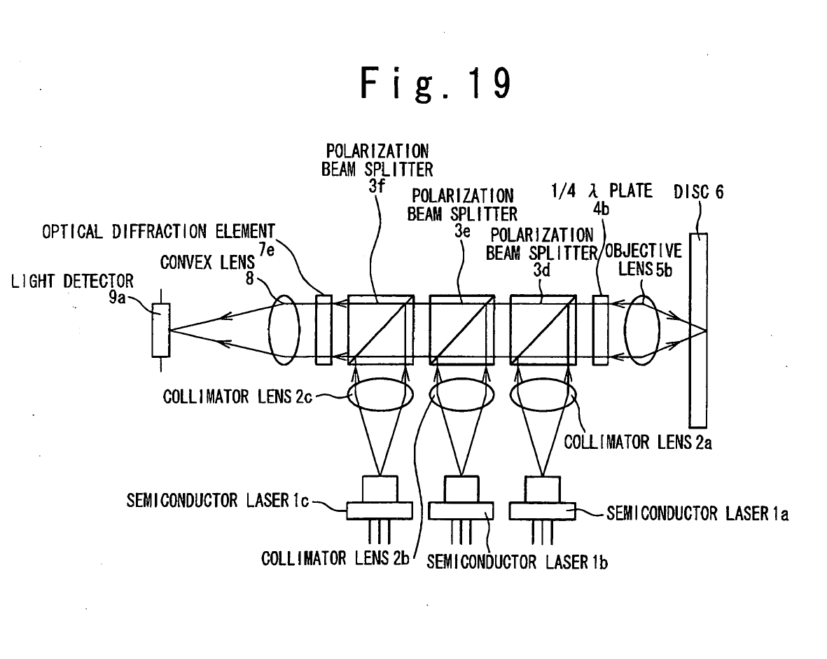

FIG. 19 shows the configuration of the optical head apparatus according to the sixth exemplary embodiment of the present invention. In this exemplary embodiment, the optical diffraction element 7d in the fifth exemplary embodiment is replaced by an optical diffraction element 7e.

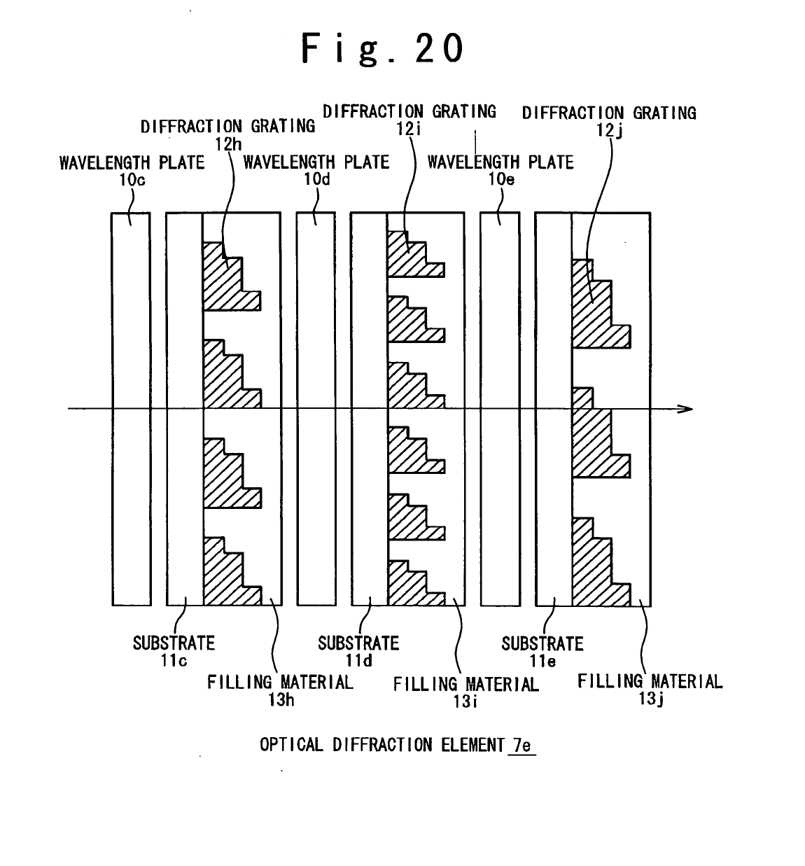

FIG. 20 is a sectional view of the optical diffraction element 7e. The optical diffraction element 7e is formed by laminating the wavelength plate 10c, a diffraction grating 12h, the wavelength plate 10d, a diffraction grating 12i, the wavelength plate 10e and a diffraction grating 12j. As the wavelength plates 10c, 10d and 10e, crystals having the birefringence property can be used, or a member can be used in which the liquid crystal polymer having the birefringence property is sandwiched with the glass substrates. The diffraction gratings 12h, 12i and 12j are formed such that patterns of the liquid crystal polymers having the birefringence property are formed on the glass substrates 11c, 11d and 11e, respectively, and they are embedded with filling materials 13h, 13i and 13j, respectively. The wavelength plate 10c, the diffraction grating 12h, the wavelength plate 10d, the diffraction grating 12i, the wavelength plate 10e and the diffraction grating 12j can be integrated with adhesive layers there between. Also, instead of the substrates 11c, 11d and 11e, the wavelength plates 10c, 10d and 10e can be also used as the substrates. The sectional shapes of the patterns of the liquid crystal polymers in the diffraction gratings 12h, 12i and 12j are the stepped shape of 4 levels.

The wavelength plates 10c and 10e function as full wavelength plates for the light beam of the wavelength 400 nm, function as a ½ waveform plate for converting the polarization direction of the input light beam by 90° for the light beam of the wavelength of 650 nm and function as a full wavelength plate for the light beam of the wavelength of 780 nm. This can be attained by setting phase differences due to the wavelength plates 10c and 10e to integer times of 2π for the light beam of the wavelength 400 nm, odd-number times of π for the light beam of the wavelength of 650 nm, and integer times of 2π for the light beam of the wavelength of 780 nm. For example, when the phase differences due to the wavelength plates 10c and 10e are set to 2π/λ×1600 nm (λ is the wavelength of the input light beam), the phase difference is 2π×4 in case of λ=400 nm, and the phase difference is π×4.92 in case of λ=650 nm, and the phase difference is 2π×2.05 in case of λ=780 nm. Thus, the foregoing condition is substantially satisfied.

The wavelength plate 10d functions as the full wavelength plate for the light beam of the wavelength 400 nm, functions as the full waveform plate for the light beam of the wavelength of 650 nm, and functions as the ½ waveform plate for converting the polarization direction of the input light by 90° for the light beam of the wavelength of 780 nm. This can be attained by setting the phase difference due to the wavelength plate 10d to integer times of 2π for the light beam of the wavelength 400 nm, integer times of 2π for the light beam of the wavelength of 650 nm and the odd-numbered times of π for the light beam of the wavelength of 780 nm. For example, when the phase difference due to the wavelength plate 10d is set at 2π/λ×2000 nm (λ is the wavelength of the input light beam), the phase difference is 2π×5 in case of λ=400 nm, and the phase difference in the case of λ=650 nm is 2π×3.08, and the phase difference in the case of λ=780 nm is π×5.13. Thus, the foregoing condition is substantially satisfied.

The directions of the grooves in the diffraction gratings 12h, 12i and 12j are perpendicular to the paper surface of FIG. 20. Here, the linear polarization in which the polarization direction is parallel to a direction of the grooves in the diffraction gratings 12h, 12i and 12j, namely, the linear polarization in a direction perpendicular to the paper surface of FIG. 20 is defined as the TE polarization, and the linear polarization in which the polarization direction is perpendicular to the direction of the grooves in the diffraction gratings 12h, 12i and 12j, namely, the linear polarization in a direction parallel to the paper surface of FIG. 20 is defined as the TM polarization. At this time, the refractive indexes of the liquid crystal polymers in the diffraction gratings 12h, 12j are different from the refractive index of the filling material for the TE polarization and same as the refractive index of the filling material for the TM polarization. Also, the refractive index of the liquid crystal polymer in the diffraction grating 12i is equal to the refractive index of the filling material for the TE polarization and different from the refractive index of the filling material for the TM polarization.

The light beam of the wavelength 400 nm for the HD DVD is inputted as the TM polarization light beam to the optical diffraction element 7e. This light beam transmits the wavelength plate 10c in the original state of the TM polarization and is inputted to the diffraction grating 12h. Thus, this light beam substantially perfectly transmits the diffraction grating 12h. This light beam transmits the wavelength plate 10d in the original state of the TM polarization and inputted to the diffraction grating 12i. Thus, this light beam is diffracted to the ± primary diffraction light beams by the diffraction grating 12i. The diffraction efficiencies of the ± primary diffraction light beams are defined based on a phase difference and a width of each level in the diffraction grating 12i, and an interval of the ± primary diffraction light beams on the light detector 9a is defined based on a pitch in the diffraction grating 12i. Those light beams transmit the wavelength plate 10e in the original state of the TM polarization and is inputted to the diffraction grating 12j. Therefore, this light beam is substantially perfectly transmits the diffraction grating 12j.

The light beam of the wavelength of 650 nm for the DVD is inputted as the TM polarization light beam to the optical diffraction element 7e. This light beam transmits the wavelength plate 10c and is converted from the TM polarization into the TE polarization and is then inputted to the diffraction grating 12h. Thus, this light beam is diffracted to the ± primary diffraction light beams by the diffraction grating 12h. The diffraction efficiencies of the ± primary diffraction light beams are defined based on a phase difference and a width of each level in the diffraction grating 12h, and an interval of the ± primary diffraction light beams on the light detector 9a is defined based on a pitch in the diffraction grating 12h. Those light beams transmit the wavelength plate 10d in their original states of the TE polarization and are inputted to the diffraction grating 12i. Thus, they substantially perfectly transmit the diffraction grating 12i. Those light beams transmit the wavelength plate 10e and are converted from the TE polarization into the TM polarization and are then inputted to the diffraction grating 12i. Therefore, they are substantially perfectly transmits the diffraction grating 12j.

The light beam of the wavelength of 780 nm for the CD is inputted as the TM polarization light beam to the optical diffraction element 7e. This light beam transmits the wavelength plate 10c in its original state of the TE polarization and is inputted to the diffraction grating 12h. Thus, this light beam substantially perfectly transmits the diffraction grating 12h. This light beam transmits the wavelength plate 10d and is converted from the TM polarization into the TE polarization and is then inputted to the diffraction grating 12i. Thus, this light beam substantially perfectly transmits the diffraction grating 12i. This light beam transmits the wavelength plate 10e in its original state of the TE polarization and is inputted to the diffraction grating 12j. Therefore, this light beam is diffracted to the ± primary diffraction light beams by the diffraction grating 12j. The diffraction efficiencies of the ± primary diffraction light beams are defined based on a phase difference and a width of each level in the diffraction grating 12j, and an interval of the ± primary diffraction light beams on the light detector 9a is defined based on a pitch in the diffraction grating 12j.

A plan view of the optical diffraction element 7e in the sixth exemplary embodiment is same as that shown in FIG. 11. In this exemplary embodiment, the arrangement of the light receiving sections in the light detector 9a and a pattern of the light spots on the light detector 9a are same as those shown in FIG. 8. In this exemplary embodiment, the method similar to the method described in the first exemplary embodiment is used to obtain a focus error signal, a track error signal and an RF signal.

In the sixth exemplary embodiment, the pitches in the regions 14e to 14h of the diffraction grating 12i are defined such that the − primary diffraction light beam of the wavelength 400 nm generates the light spots 16a to 16d on the light detector 9a, respectively, and the + primary diffraction light beam generates the light spots 16e to 16h on the light detector 9a, respectively. Also, the pitches in the regions 14e to 14h of the diffraction grating 12h are defined such that the − primary diffraction light beam of the wavelength of 650 nm generates the light spots 16a to 16d on the light detector 9a, respectively, and the + primary diffraction light beam generates the light spots 16e to 16h on the light detector 9a, respectively. Also, the pitches in the regions 14e to 14h of the diffraction grating 12j are defined such that the − primary diffraction light beam of the wavelength of 780 nm generates the light spots 16a to 16d on the light detector 9a, respectively, and the + primary diffraction light beam generates the light spots 16e to 16h on the light detector 9a, respectively.

In the sixth exemplary embodiment, the phase difference between the adjacent levels of the diffraction grating 12i with regard to the TM polarization light beam is assumed to be π/2 for the wavelength 400 nm. Also, the widths of the 0-th level and the second level in the stepped shape of the diffraction grating 12i are assumed to be wider or narrower than the widths of the first level and the third level. At this time, for example, the − primary diffraction efficiency of the light beam of the wavelength 400 nm can be assumed to be 9%, and the + primary diffraction light beam can be assumed to be 72%. Also, the phase difference between the adjacent levels of the diffraction grating 12h with regard to the TE polarization light beam is assumed to be π/2 for the wavelength of 650 nm. Moreover, the widths of the 0-th level and the second level are assumed to be wider or narrower than the widths of the first level and the third level. At this time, for example, the − primary diffraction efficiency of the light beam of the wavelength of 650 nm can be assumed to be 9%, and the + primary diffraction light beam can be assumed to be 72%. Also, the phase difference between the adjacent levels of the diffraction grating 12j with regard to the TE polarization light beam is assumed to be π/2 for the wavelength of 780 nm. Moreover, the widths of the 0-th level and the second level are assumed to be wider or narrower than the widths of the first level and the third level. At this time, for example, the − primary diffraction efficiency of the light beam of the wavelength of 780 nm can be assumed to be 9%, and the + primary diffraction efficiency can be assumed to be 72%.

According to the sixth exemplary embodiment, the diffraction efficiency of the + primary diffraction light beam used to detect the RF signal can be increased, thereby increasing the signal to noise ratio in the RF signal.

The functions of the wavelength plates 10c, 10d and 10e in the sixth exemplary embodiment are not always required to comply with the description in FIG. 20, because of the reason similar to the reason described in the fifth exemplary embodiment. Also, the functions of the diffraction gratings 12h, 12i and 12j in this exemplary embodiment are not always required to comply with the description in FIG. 20, because of the reason similar to the reason described in the fifth exemplary embodiment.

### Seventh Exemplary Embodiment

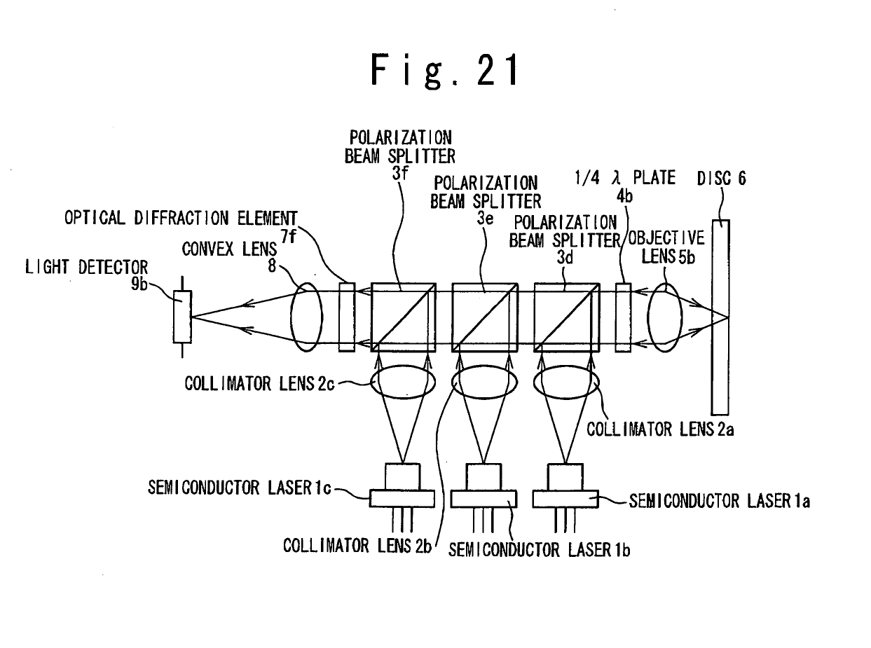

FIG. 21 shows the configuration of the optical head apparatus in the seventh exemplary embodiment of the present invention. In the optical head apparatus of the seventh exemplary embodiment, the optical diffraction element 7d of the optical head apparatus shown in FIG. 17 in the fifth exemplary embodiment is replaced by an optical diffraction element 7f, and the light detector 9a is replaced by the light detector 9b. The sectional view of the optical diffraction element 7f in the seventh exemplary embodiment is equal to that shown in FIG. 18. The plan view of the optical diffraction element 7f in this exemplary embodiment is same as that shown in FIG. 13. The arrangement of the light receiving sections of the light detector 9b and a pattern of the light spots on the light detector 9b are same as those shown in FIG. 14. In this exemplary embodiment, the method similar to the method described in the third exemplary embodiment is used to obtain a focus error signal, a track error signal and an RF signal.

In the seventh exemplary embodiment, the pitch in the diffraction grating 12f is defined such that the − primary diffraction light beam of the wavelength 400 nm generates the light spot 16i on the light detector 9b, and the + primary diffraction light beam generates the light spot 16j on the light detector 9b. Also, the pitch in the diffraction grating 12e is defined such that the − primary diffraction light beam of the wavelength of 650 nm generates the light spot 16i on the light detector 9b, and the + primary diffraction light beam generates the light spot 16j on the light detector 9b. Also, the pitch of the diffraction gratin 12g is defined such that the − primary diffraction light beam of the wavelength of 780 nm generates the light spot 16i on the light detector 9b, and the + primary diffraction light beam generates the light spot 16j on the light detector 9b.

In the seventh exemplary embodiment, it is supposed that the phase difference between a line portion and a space portion in the diffraction grating 12f with respect to the TM polarization light beam is π for the wavelength 400 nm. At this time, the ± primary diffraction efficiencies of the light beam of the wavelength 400 nm are respective 40.5%. Also, it is supposed that the phase difference between the line portion and the space portion of the diffraction grating 12e with respect to the TE polarization is π for the wavelength of 650 nm. At this time, the ± primary diffraction efficiencies of the light beam of the wavelength of 650 nm are respective 40.5%. Also, it is supposed that the phase difference between the line portion and the space portion of the diffraction grating 12g with respect to the TE polarization light beam is λ for the wavelength of 780 nm. At this time, the ± primary diffraction efficiencies of the light beam of the wavelength of 780 nm are respective 40.5%.

The functions of the wavelength plates 10c, 10d and 10e in the seventh exemplary embodiment are not always required to comply with the description in FIG. 18, because of the reason described in the fifth exemplary embodiment. Also, the diffraction gratings 12e, 12f and 12g in this exemplary embodiment are not always required to comply with the description in FIG. 18, because of the reason described in the fifth exemplary embodiment.

### Eighth Exemplary Embodiment

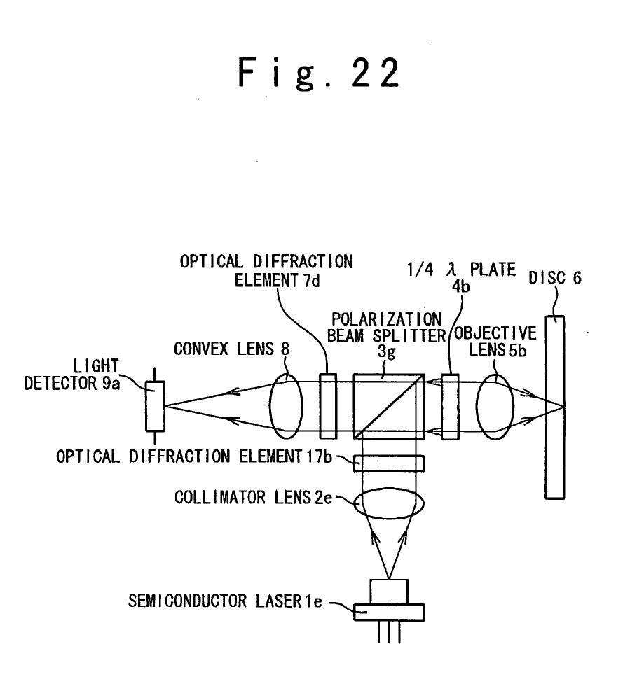

FIG. 22 shows an optical head apparatus according to the eighth exemplary embodiment of the present invention. In the semiconductor laser 1e, the semiconductor laser for outputting the light of the 400 nm for the HD DVD, the semiconductor laser for outputting the light beam of the wavelength of 650 nm for the DVD, and the semiconductor laser for outputting the light beam of the wavelength of 780 nm for the CD are accommodated in a common package. The light beam of the wavelength 400 nm outputted from the semiconductor laser 1e is converted into a parallel light beam by the collimator lens 2e, transmits an optical diffraction element 17b, is inputted as the S polarization to the polarization beam splitter 3g, and is reflected for approximate 100%. The reflected light beam transmits the ¼ wavelength plate 4b, is converted from the linear polarization into the circular polarization, and is then collected onto the disc 6 serving as the optical recording medium based on the HD DVD standard by the objective lens 5b. The light reflected by the disc 6 transmits the objective lens 5b in a direction opposite to the input direction to the disc 6, transmits the ¼ wavelength plate 4b, is converted from the circular polarization into the linear polarization in which the forward path direction and the polarization direction are orthogonal. The converted light beam is inputted as the P polarization to the polarization beam splitter 3g, and transmits for approximate 100%. The transmitting light beam is diffracted by the optical diffraction element 7d, transmits the convex lens 8, and is then received by the light detector 9a.

The light beam of the wavelength of 650 nm outputted from the semiconductor laser 1e is converted into a parallel light beam by the collimator lens 2e, is diffracted by the optical diffraction element 17b, and is inputted as the S polarization to the polarization beam splitter 3g. The inputted light beams is reflected for approximately 100%, transmits the ¼ wavelength plate 4b, and is converted from the linear polarization into the circular polarization. The converted light beam is then collected onto the disc 6 serving as the optical recording medium based on the DVD standard by the objective lens 5b. The light reflected by the disc 6 transmits the objective lens 5b in a direction opposite to the input direction to the disc 6, transmits the ¼ wavelength plate 4b, and is converted from the circular polarization into the linear polarization in which the forward path direction and the polarization direction are orthogonal. The converted light beam is inputted as the P polarization to the polarization beam splitter 3g, transmits for approximate 100% and is diffracted by the optical diffraction element 7d. The diffracted light beam transmits the convex lens 8 and is then received by the light detector 9a.

The light beam of the wavelength of 780 nm outputted from the semiconductor laser 1e is converted into a parallel light beam by the collimator 2e, is diffracted by the optical diffraction element 17b, and inputted as the S polarization to the polarization beam splitter 3g. The inputted light beam is reflected for approximate 100%, transmits the ¼ wavelength plate 4b, and is converted from the linear polarization into the circular polarization. The converted light beam is then collected onto the disc 6 serving as the optical recording medium based on the CD standard by the objective lens 5b. The light reflected by the disc 6 transmits the objective lens 5b in a direction opposite to the input direction to the disc 6, transmits the ¼ wavelength plate 4b, and is converted from the circular polarization into the linear polarization in which the forward path direction and the polarization direction are orthogonal. The converted light beam is inputted as the P polarization to the polarization beam splitter 3g, transmits for approximate 100%, is diffracted by the optical diffraction element 7d, transmits the convex lens 8, and is then received by the light detector 9a.

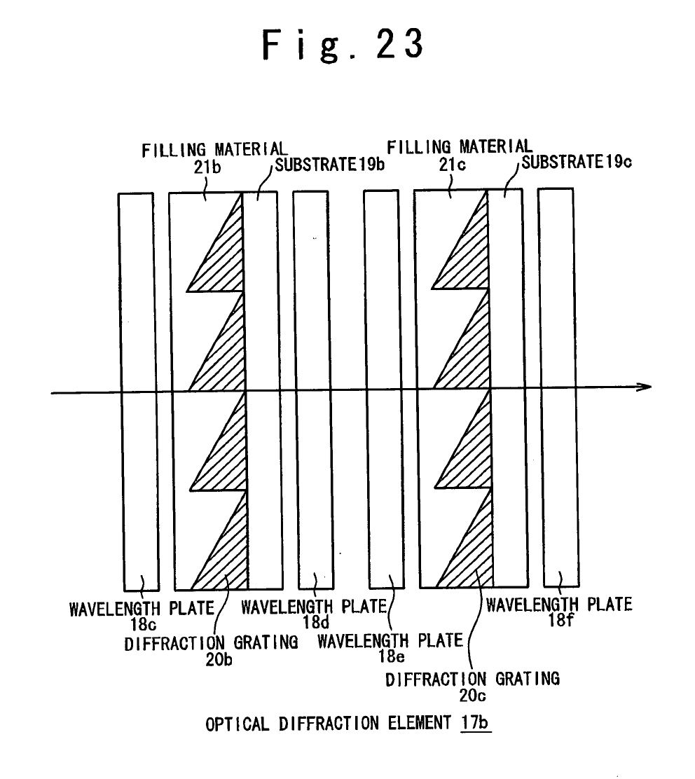

FIG. 23 is a sectional view of the optical diffraction element 17b. The optical diffraction element 17b is formed by laminating a wavelength plate 18c, a diffraction grating 20b, a wavelength plate 18d, a wavelength plate 18e, a diffraction grating 20c and a wavelength plate 18f. As the wavelength plates 18c, 18d, 18e and 18f, crystals having the birefringence property can be used, or a member can be used in which the liquid crystal polymer having the birefringence property is sandwiched with glass substrates. The diffraction gratings 20b and 20c are formed such that the patterns of the liquid crystal polymer having the birefringence property are formed on glass substrates 19b and 19c, and they are embedded with filling materials 21b and 21c. The wavelength plate 18c, the diffraction grating 20b, the wavelength plate 18d, the wavelength plate 18e, the diffraction grating 20c and the wavelength plate 18f can be integrated with adhesive layers therebetween. Also, instead of the substrates 19b and 19c, the wavelength plates 18d and 18f can be also used as the substrates. The flat surface shapes of the patterns of the liquid crystal polymer in the diffraction gratings 20b and 20c have the shapes of the straight lines of a same pitch, and the sectional shapes have the shapes of saw teeth.

The wavelength plates 18c and 18d function as full wavelength plates for the light beam of the wavelength 400 nm, functions as a ½ waveform plate for converting the polarization direction of the input light by 90° for the light beam of the wavelength of 650 nm and functions as a full wavelength plate for the light beam of the wavelength of 780 nm. The wavelength plates 18e and 18f function as full wavelength plate for the light beam of the wavelength 400 nm, function as a full wavelength plate for the light beam of the wavelength of 650 nm and function as a ½ waveform plate for converting the polarization direction of the input light by 90° for the light beam of the wavelength of 780 nm. The direction of the grooves of the diffraction gratings 20b and 20c are perpendicular to the paper surface of the drawing. Here, the linear polarization in which the polarization direction is parallel to the direction of the grooves of the diffraction gratings 20b and 20c, namely, the linear polarization in a direction perpendicular to the paper surface on the drawing is defined as the TE polarization, and the linear polarization in which the polarization direction is perpendicular to the direction of the grooves of the diffraction gratings 20b and 20c, namely, the linear polarization in a direction parallel to the paper surface on the drawing is defined as the TM polarization. At this time, the refractive indexes of the liquid crystal polymers in the diffraction gratings 20b and 20c are same as the refractive index of the filling material for the TE polarization and different from the refractive index of the filling material for the TM polarization.

The light beam of the wavelength 400 nm for the HD DVD is inputted as the TE polarization to the optical diffraction element 17b. This light beam transmits the wavelength plate 18c in its original state of the TE polarization and then is inputted to the diffraction grating 20b. Thus, this light beam substantially perfectly transmits the diffraction grating 20b. This light beam transmits the wavelength plate 18d in its original state of the TE polarization and transmits the wavelength plate 18e in its original state of the TE polarization and then is inputted to the diffraction grating 20c. Thus, this light beam substantially perfectly transmits the diffraction grating 20c. This light beam transmits the wavelength plate 18f in its original state of the TE polarization and is outputted as the TE polarization from the optical diffraction element 17b.

The light beam of the wavelength of 650 nm for the DVD is inputted as the TE polarization light beam to the optical diffraction element 17b. This light beam transmits the wavelength plate 18c and is converted from the TE polarization into the TM polarization and is then inputted to the diffraction grating 20b. Thus, this light beam is substantially perfectly diffracted to the primary diffraction light beams by the diffraction grating 20b. This light beam transmits the wavelength plate 18d, is converted from the TM polarization into the TE polarization, transmit the wavelength plate 18e in its original state of the TE polarization, and is then inputted to the diffraction grating 20c. Thus, this light beam substantially perfectly transmits the diffraction grating 20c. This light beam transmits the wavelength plate 18f in its original state of the TE polarization, and is outputted as the TE polarization light beam from the optical diffraction element 17b.

The light beam of the wavelength of 780 nm for the CD is inputted as the TE polarization light beam to the optical diffraction element 17b. This light beam transmits the wavelength plate 18c in its original state of the TE polarization and is inputted to the diffraction grating 20b. Thus, this light beam substantially perfectly transmits the diffraction grating 20b. This light beam transmits the wavelength plate 18d in its original state of the TE polarization, transmits the wavelength plate 18e, is converted from the TE polarization into the TM polarization, and is then inputted to the diffraction grating 20c. Thus, this light beam is substantially perfectly diffracted to the primary diffraction light beam by the diffraction grating 20c. This light beam transmits the wavelength plate 18f and is converted from the TM polarization into the TE polarization and is then outputted as the TE polarization light beam from the optical diffraction element 17b.

When the light emission point of the semiconductor laser for the HD DVD built in the semiconductor laser 1e is made coincident with the optical axis of the objective lens 5b, the light emission points of the semiconductor lasers for the DVD and the CD built in the semiconductor laser 1e are displaced from the optical axis of the objective lens 5b. At this time, since the orientations and pitches of the saw teeth of the diffraction gratings 20b and 20c are suitably defined on the basis of the orientations of the displacements and intervals of the light emission points of the semiconductor lasers for the HD DVD, the DVD and the CD, the apparent light emission points of the semiconductor lasers for the DVD and the CD can be made coincident with the optical axis of the objective lens 5b. The phase differences of the diffraction gratings 20b and 20c are defined so as to maximum the diffraction efficiency of the primary diffraction light beam.

A sectional view of the optical diffraction element 7d in the eighth exemplary embodiment is the same as that shown in FIG. 18. A plan view of the optical diffraction element 7d in the eighth exemplary embodiment is the same as that shown in FIG. 7. In this exemplary embodiment, the arrangement of the light receiving sections of the light detector 9a and a pattern of the light spots on the light detector 9a is the same as those shown in FIG. 8. In the eighth exemplary embodiment, the method similar to the method described in the first exemplary embodiment is used to obtain a focus error signal, a track error signal and a RF signal. In the eighth exemplary embodiment, the method similar to the method described in the fifth exemplary embodiment is used to define the pitches and phase differences in the diffraction gratings 12e, 12f and 12g.

The functions of the wavelength plates 10c, 10d and 10e in the eighth exemplary embodiment are not always required to comply with the description in FIG. 18, because of the reason similar to the reason described in the fifth exemplary embodiment. Also, the diffraction gratings 12e, 12f and 12g in this exemplary embodiment are not always required to comply with the description in FIG. 18, because of the reason similar to the reason described in the fifth exemplary embodiment.

As the optical head apparatus in the exemplary embodiment of the present invention, the optical diffraction element 7d in the eighth exemplary embodiment is replaced by the optical diffraction element 7e. Also, the optical diffraction element 7d in the eighth exemplary embodiment is replaced by the optical diffraction element 7f and the light detector 9a is replaced by the light detector 9b.

Typically, the objective lens used in the optical head apparatus is designed such that spherical aberration is compensated for the particular wavelength and the thickness of a protective layer of a particular optical recording medium. Thus, the spherical aberration is generated for the different wavelength or the thickness of the protective layer of the different optical recording medium. Thus, in order to perform the record/reproduction to the plurality of kinds of the optical recording media, the spherical aberration is required to be compensated on the basis of the optical recording medium. For this reason, in the exemplary embodiment of the optical head apparatus of the present invention, a spherical aberration compensating unit for compensating the spherical aberration on the basis of the optical recording medium is installed in the optical system as necessary. The spherical aberration compensating unit operates to change the magnification of the objective lens on the basis of the optical recording medium. Changing the magnification of the objective lens changes the spherical aberration on the objective lens. Thus, in such a way that the spherical aberration caused by the fact that the wavelength or the thickness of the protective layer of the optical recording medium differs from the design is cancelled by the spherical aberration caused by the magnification change of the objective lens, the spherical aberration compensating unit is used to control the magnification of the objective lens. Also, in order to perform the record/reproduction to the plurality of kinds of the optical recording media, a numerical aperture of the objective lens is required to be controlled on the basis of the optical recording medium. For this reason, in the exemplary embodiment of the optical head apparatus of the present invention, an aperture control unit for controlling the numerical aperture of the objective lens on the basis of the optical recording medium is installed in the optical system as necessary.

[Optical Information Recording/Reproducing Apparatus]

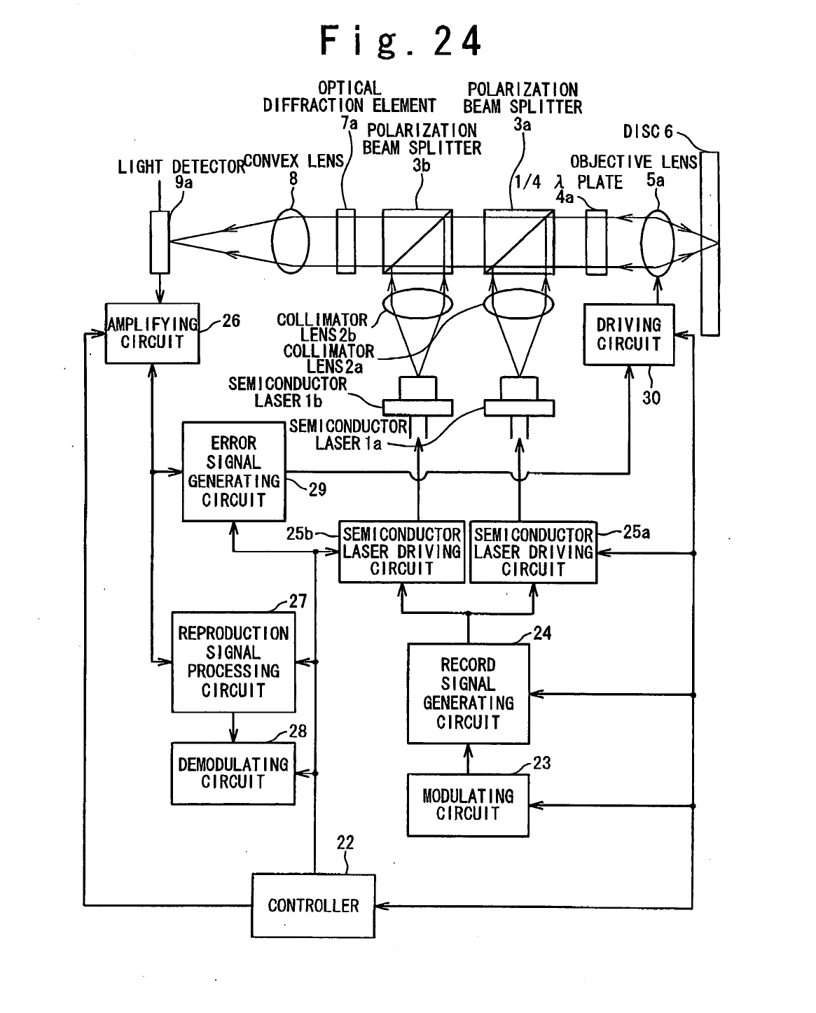

FIG. 24 shows the configuration of the optical information recording/reproducing apparatus according to an exemplary embodiment of the present invention. In this exemplary embodiment, a controller 22, a modulating circuit 23, a record signal generating circuit 24, semiconductor laser driving circuits 25a and 25b, an amplifying circuit 26, a reproduction signal processing circuit 27, a demodulating circuit 28, an error signal generating circuit 29 and an objective lens driving circuit 30 are added to the optical head apparatus according to the first exemplary embodiment of the present invention shown in FIG. 5.

The modulating circuit 23 modulates a data to be recorded onto the disc 6, in accordance with a modulation rule. The record signal generating circuit 24 generates a record signal for driving the semiconductor laser 1a or 1b in accordance with a record strategy, on the basis of the signal modulated by the modulating circuit 23. The semiconductor laser driving circuit 25a or 25b supplies a current to the semiconductor laser 1a or 1b based on the record signal generated by the record signal generating circuit 24 to drive the semiconductor laser 1a or 1b. Consequently, the data is recorded onto the disc 6.

The amplifying circuit 26 amplifies an output from each light receiving section of the light detector 9a. The reproduction signal processing circuit 27 carries out the generation of an RF signal, waveform equalization and conversion into a binary number. The demodulating circuit 28 demodulates the signal that is converted into the binary number by the reproduction signal processing circuit 27, in accordance with a demodulation rule. Thus, the data is reproduced from the disc 6.

The error signal generating circuit 29 generates a focus error signal and a track error signal in accordance with the signal amplified by the amplifying circuit 26. The objective lens driving circuit 30 supplies the current to an actuator (not shown) based on the error signals generated by the error signal generating circuit 29 to drive the objective lens 5a.

Moreover, an optical system except the disc 6 is driven to the radius direction of the disc 6 by a positioning unit (not shown), and the disc 6 is rotationally driven by a spindle motor (not shown). Consequently, servo controls of a focus, a track, a positioning and a spindle are carried out.

The circuits concerned with the recoding of the data between the modulating circuit 23 and the semiconductor laser driving circuits 25a and 25b, the circuits concerned with the reproducing of the data between the amplifying circuit 26 and the demodulating circuit 28, and the circuits concerned with the servo control between the amplifying circuit 26 and the objective lens driving circuit 30 are controlled by the controller 22.

This exemplary embodiment is the information recording/reproducing apparatus for performing the record/reproduction on the disc 6. On the contrary, as the exemplary embodiment of the optical information recording/reproducing apparatus of the present invention, a dedicated reproducing apparatus for performing only the reproduction on the disc 6 may be employed. In this case, the semiconductor laser 1a or 1b is not driven in accordance with the record signal by the semiconductor laser driving circuit 25a or 25b, and this is driven such that the power of the output light has the constant value.

As the exemplary embodiment of the optical information recording/reproducing apparatus of the present invention, the controller, the modulating circuit, the record signal generating circuit, the semiconductor laser driving circuit, the amplifying circuit, the reproduction signal processing circuit, the demodulating circuit, the error signal generating circuit and the objective lens driving circuit may be added to the second to eighths exemplary embodiment of the optical head apparatus of the present invention.

In the optical head apparatus of the present intention and the optical information recording/reproducing apparatus that contains the optical head apparatus, the optical diffraction element, which includes a material having the birefringence property and generates the plurality of diffraction light beams from each of the plurality of light beams whose wavelengths are different, is installed between the light detecting section and a light splitter for separating the light on the forward path and the light on the return path. Thus, a ratio of the light quantities of the plurality of diffraction light beams and an interval between the plurality of diffraction light beams on the light detecting section are independently designed for each of the plurality of light beams whose wavelengths are different. Thus, the light detecting sections of the light detector can be standardized for the plurality of kinds of the optical recording media. Also, the number of the pins required to output a signal can be reduced in the light detecting section. Moreover, the diffraction efficiency of the optical diffraction element can be increased for each of the plurality of light beams whose wavelengths are different. As a result, in order to perform the record/reproduction on the plurality of kinds of the optical recording media, the optical head apparatus which is small in size and high in efficiency and the optical information recording/reproducing apparatus that contains the optical head apparatus can be attained.

1. An optical head apparatus comprising:
a light source section having a plurality of light sources configured to output a plurality of light beams whose wavelengths are different from each other;
an objective lens configured to collect one of said plurality of light beams from said light source section as an output light beam onto an optical recording medium;
a light separating section configured to send said output light beam from said light source section to said objective lens;
wherein said output light beam is reflected as a reflection light beam by said optical recording medium, and said reflection light beam is inputted through said objective lens to said light separating section, and said light separating section sends said reflection light beam to a direction different from said light source section;
an optical diffracting section configured to generate a plurality of diffraction light beams from said reflection light beam sent through said light separating section; and
a light detector having light receiving sections configured to receive said plurality of diffraction light beams.

2. The optical head apparatus according to claim 1, wherein ratios of light quantities of said plurality of diffraction light beams generated by said optical diffracting section are approximately equal to each other over a plurality of said reflection light beams obtained from said plurality of light beams.

3. The optical head apparatus according to, claim 1, wherein positions of a plurality of light spots generated on said light receiving sections of said light detector from said plurality of diffraction light beams are approximately the same over a plurality of said reflection light beams obtained from said plurality of light beams.

4. The optical head apparatus according to claim 1, wherein said optical diffracting section comprises:
a plurality of diffraction gratings which are respectively provided for a plurality of said reflection light beams obtained from said plurality of light beams, and which are laminated.

5. The optical head apparatus according to claim 4, wherein a polarization direction of one of said plurality of reflection light beams corresponding to one of said plurality of diffraction gratings among said plurality of reflection light beams inputted to said plurality of diffraction gratings is orthogonal to polarization directions of the remaining reflection light beams.

6. The optical head apparatus according to claim 4, wherein each of said plurality of diffraction gratings diffracts the corresponding reflection light beam and transmits the remaining reflection light beams and the diffraction light beams obtained from the remaining reflection light beams.

7. The optical head apparatus according to claim 4, wherein said optical diffracting section further comprises a plurality of wavelength plates provided for said plurality of diffraction gratings on input sides of said plurality of diffraction gratings, respectively, and
each of said plurality of wavelength plates orthogonalizes a polarization direction of one of said plurality of reflection light beams corresponding to said diffraction gratings corresponding to said wavelength plate to polarization directions of the remaining reflection light beams.

8. The optical head apparatus according to claim 4, wherein said plurality of diffraction gratings are formed of material having birefringence property.

9. An optical information recording/reproducing apparatus comprising:
an optical head apparatus comprising:
a light source section having a plurality of light sources configured to output a plurality of light beams whose wavelengths are different from each other;
an objective lens configured to collect an output light beam as one of said plurality of light beams from said light source section onto an optical recording medium;
a light separating section configured to send said output light beam from said light source section to said objective lens;
wherein said output light beam is reflected as a reflection light beam by said optical recording medium, and said reflection light beam is inputted through said objective lens to said light separating section, and said light separating section sends said reflection light beam to a direction different from said light source section;
an optical diffracting section configured to generate a plurality of diffraction light beams from said reflection light beam sent through said light separating section; and
a light detector having light receiving sections configured to receive said plurality of diffraction light beams;
a first circuit configured to drive said light source section such that one of said plurality of light beams is outputted as said output light beam;
a second circuit configured to generate a reproduction signal and an error signal based on an output signal from said light detector; and
a third circuit configured to control a position of said objective lens based on said error signal.

10. An optical information recording/reproducing method, comprising:
selectively driving one of a plurality of light sources of a light source section to output an output light beam, wherein said plurality of light sources can output a plurality of light beams whose wavelengths are different from each other;
sending said output light beam from said light source section to an objective lens through a light separating section;
collecting said output light beam onto an optical recording medium by said objective lens;
generating a plurality of diffraction light beams by an optical diffracting section from a reflection light beam reflected from said optical recording medium and sent to a direction different from said light source section through said light separating section;
receiving said plurality of diffraction light beams by light receiving sections of a light detector;
generating a reproduction signal and an error signal based on an output signal from said light detector; and
controlling a position of said objective lens based on said error signal.

11. The optical information recording/reproducing method according to claim 10, wherein ratios of light quantities of said plurality of diffraction light beams are approximately equal over a plurality of said reflection light beams obtained from said plurality of light beams.

12. The optical information recording/reproducing method according to claim 10, wherein positions of a plurality of light spots generated on said light receiving sections of said light detector from said plurality of diffraction light beams are approximately the same over a plurality of said reflection light beams obtained from said plurality of light beams.

13. The optical information recording/reproducing method according to claim 10, wherein said optical diffracting section comprises a plurality of diffraction gratings which are laminated and provided for a plurality of said reflection light beams obtained from said plurality of light beams, respectively, and
said generating said plurality of diffraction light beams comprises:
diffracting each of said plurality of reflection light beams by a corresponding one of said plurality of diffraction gratings and transmitting the remaining reflection light beams and diffraction light beams obtained from the remaining reflection light beams.

14. The optical information recording/reproducing method according to claim 13, wherein said generating said plurality of diffraction light beams comprises:
orthogonalizing a polarization direction of one of said plurality of reflection light beams corresponding to one of said plurality of diffraction gratings among said plurality of reflection light beams inputted to said plurality of diffraction gratings to polarization directions of the remaining reflection light beams.

15. The optical information recording/reproducing method according to claim 9, wherein ratios of light quantities of said plurality of diffraction light beams generated by said optical diffracting section are approximately equal to each other over a plurality of said reflection light beams obtained from said plurality of light beams.

16. The optical information recording/reproducing method according to claim 9, wherein positions of a plurality of light spots generated on said light receiving sections of said light detector from said plurality of diffraction light beams are approximately the same over a plurality of said reflection light beams obtained from said plurality of light beams.

17. The optical information recording/reproducing method according to claim 9, wherein said optical diffracting section comprises:
a plurality of diffraction gratings which are respectively provided for a plurality of said reflection light beams obtained from said plurality of light beams, and which are laminated.

18. The optical information recording/reproducing method according to claim 17, wherein a polarization direction of one of said plurality of reflection light beams corresponding to one of said plurality of diffraction gratings among said plurality of reflection light beams inputted to said plurality of diffraction gratings is orthogonal to polarization directions of the remaining reflection light beams.

19. The optical information recording/reproducing method according to claim 17, wherein each of said plurality of diffraction gratings diffracts the corresponding reflection light beam and transmits the remaining reflection light beams and the diffraction light beams obtained from the remaining reflection light beams.

20. The optical information recording/reproducing method according to claim 17, wherein said optical diffracting section further comprises a plurality of wavelength plates provided for said plurality of diffraction gratings on input sides of said plurality of diffraction gratings, respectively, and
each of said plurality of wavelength plates orthogonalizes a polarization direction of one of said plurality of reflection light beams corresponding to said diffraction grating corresponding to said wavelength plate to polarization directions of the remaining reflection light beams.
